(19) United States
(12) Patent Application Publication
(10) Pub. No.: US 2025/0234126 A1
(43) Pub. Date: Jul. 17, 2025

(54) ACOUSTIC CONTROL METHOD AND ACOUSTIC CONTROL DEVICE

(71) Applicant: SONY GROUP CORPORATION, TOKYO (JP)

(72) Inventors: KAZUYA TATEISHI, TOKYO (JP); SHUSUKE TAKAHASHI, TOKYO (JP); MASATO HIRANO, TOKYO (JP); ATSUO HIROE, TOKYO (JP); YUICHIRO KOYAMA, TOKYO (JP); YUUJI MAEDA, TOKYO (JP); RYOSUKE SAWATA, TOKYO (JP); KAZUKI SHIMADA, TOKYO (JP); AKIRA TAKAHASHI, TOKYO (JP); TOSHIMITSU UESAKA, TOKYO (JP); ZHI ZHONG, TOKYO (JP)

(21) Appl. No.: 18/855,693

(22) PCT Filed: Apr. 10, 2023
(86) PCT No.: PCT/JP2023/014514

§ 371 Date: Oct. 10, 2024

(30) Foreign Application Priority Data
Apr. 18, 2022 (JP) 2022-068276

(51) Int. Cl. H04R 1/32; G01C 21/36

(52) U.S. Cl. CPC H04R 1/326; G01C 21/3608; G01C 21/3632

(57) ABSTRACT

An acoustic control method according to an embodiment includes: acquiring sensor data from two or more sensors mounted on a moving body that moves in a three-dimensional space; acquiring a position of the moving body; specifying a sound source and a position of the sound source outside the moving body on a basis of output of acoustic event information acquisition processing using the sensor data as input; and displaying, on a display, a moving body icon corresponding to the moving body, in which the display further displays metadata of the sound source that has been specified in a visually identifiable manner reflecting a relative positional relationship between the position of the moving body and the position of the sound source that has been specified.

### FIELD

The present disclosure relates to an acoustic control method and an acoustic control device.

### BACKGROUND

In recent years, due to improvement in sound insulating properties of a passenger car (hereinafter, simply referred to as a car), there has been a need to take in environmental sound and the like outside the car into the inside of the car and to provide the sound to a driver, a passenger, and others (hereinafter, referred to as users).

### CITATION LIST

### Patent Literature

Patent Literature 1: JP 2015-32155 A

### SUMMARY

### Technical Problem

However, in the related art, a necessary acoustic event for a user is registered in advance, and the user is notified only at the time of the target sound, and there is technology of “differentiating operations between when the car is moving and when the car is stopped”. However, there is a possibility that the music reproduction is hindered when the user enjoys music in the car in the case of notification only by the sound. Moreover, in a case where there is a plurality of registered events, there is no means of appropriately notifying a passenger in the car of a plurality of pieces of acoustic event information occurring outside the car depending on a sound source position, a direction, a type, and the like which are characteristics of the events. For this reason, there is a possibility that the safety of driving is lowered, for example, sound of a target object to be noted by the driver is not reproduced or external sound irrelevant to driving is reproduced.

Therefore, the present disclosure proposes an acoustic control method and an acoustic control device capable of suppressing deterioration in driving safety.

### Solution to Problem

In order to solve the above problem, an acoustic control method according to one embodiment of the present disclosure includes: acquiring sensor data from two or more sensors mounted on a moving body that moves in a three-dimensional space; acquiring a position of the moving body; specifying a sound source and a position of the sound source outside the moving body on a basis of output of acoustic event information acquisition processing using the sensor data as input; and displaying, on a display, a moving body icon corresponding to the moving body, wherein the display further displays metadata of the sound source that has been specified in a visually identifiable manner reflecting a relative positional relationship between the position of the moving body and the position of the sound source that has been specified.

### BRIEF DESCRIPTION OF DRAWINGS

FIG. 1 is a block diagram illustrating a configuration example of a vehicle control system.

FIG. 2 is a diagram illustrating an example of sensing areas.

FIG. 3 is a block diagram illustrating a schematic configuration example of an acoustic control device according to an embodiment of the present disclosure.

FIG. 4 is a diagram for explaining a case where a moving body approaches from a viewing angle at an intersection.

FIG. 5 is a diagram for explaining a case where a moving body approaches from a viewing angle at the time of traveling backward.

FIG. 6 is a diagram for describing a case where an emergency vehicle is approaching an area that is a blind spot due to a truck or the like.

FIG. 7 is a diagram illustrating an example of exterior microphones according to an embodiment of the present disclosure.

FIG. 8 is a diagram illustrating another example of exterior microphones according to an embodiment of the present disclosure.

FIG. 9 is a diagram illustrating an arrangement example of exterior microphones in a case of detecting sound from all directions according to an embodiment of the present disclosure.

FIG. 10 is a diagram illustrating an arrangement example of exterior microphones in a case of detecting sound from a specific direction according to an embodiment of the present disclosure.

FIG. 11 is a diagram illustrating an arrangement example of exterior microphones in a case of detecting sound from a lower tail direction of a vehicle according to an embodiment of the present disclosure.

FIG. 12 is a diagram illustrating a configuration example of exterior microphones according to an embodiment of the present disclosure.

FIG. 13 is a diagram for explaining arrival time differences of sound to the microphones illustrated in FIG. 12.

FIG. 14 is a diagram for explaining tracking of sound directions according to an embodiment of the present disclosure (part 1).

FIG. 15 is a diagram for explaining tracking of sound directions according to an embodiment of the present disclosure (part 2).

FIG. 16 is a diagram for explaining an example of microphone arrangement of exterior microphones according to an embodiment of the present disclosure (part 1).

FIG. 17 is a diagram for explaining an example of microphone arrangement of exterior microphones according to an embodiment of the present disclosure (part 2).

FIG. 18 is a diagram for explaining an example of microphone arrangement of exterior microphones according to an embodiment of the present disclosure (part 1).

FIG. 19 is a block diagram for describing an acoustic event specifying method according to an embodiment of the present disclosure.

FIG. 20 is a block diagram for describing an acoustic event specifying method according to an embodiment of the present disclosure.

FIG. 21 is a diagram illustrating a display application for the sound direction according to a first display example of an embodiment of the present disclosure.

FIG. 22 is a diagram illustrating a display application for the distance according to a first display example of an embodiment of the present disclosure.

FIG. 23 is a diagram illustrating a display application for the sound direction according to a second display example of an embodiment of the present disclosure.

FIG. 24 is a diagram illustrating a display application for the sound direction according to a third display example of an embodiment of the present disclosure.

FIG. 25 is a diagram illustrating a display application for the sound direction according to a fourth display example of an embodiment of the present disclosure.

FIG. 26 is a diagram illustrating a display application for the distance according to a fifth display example of an embodiment of the present disclosure (part 1).

FIG. 27 is a diagram illustrating the display application for the distance according to the fifth display example of the embodiment of the present disclosure (part 2).

FIG. 28 is a diagram for explaining a disc chart designed as a GUI according to an embodiment of the present disclosure (part 1).

FIG. 29 is a diagram for explaining the disc chart designed as the GUI according to the embodiment of the present disclosure (part 2).

FIG. 30 is a table summarizing determination criteria examples of notification priorities with regards to an emergency vehicle according to an embodiment of the present disclosure.

FIG. 31 is a block diagram for explaining a notification operation according to an embodiment of the present disclosure.

FIG. 32 is a flowchart illustrating an example of a notification operation related to an emergency vehicle according to an embodiment of the present disclosure.

FIG. 33 is a diagram illustrating a use example of in-vehicle speakers according to an embodiment of the present disclosure.

FIG. 34 is a diagram illustrating another use example of the in-vehicle speakers according to the embodiment of the present disclosure.

FIG. 35 is a diagram illustrating still another use example of in-vehicle speakers according to an embodiment of the present disclosure.

FIG. 36 is a diagram for explaining a situation at the time of changing lanes.

FIG. 37 is a diagram for describing a notification example in a case where changing lanes is stopped (part 1).

FIG. 38 is a diagram for describing the notification example in the case where changing lanes is stopped (part 2).

FIG. 39 is a diagram for explaining a situation at the time of a left turn.

FIG. 40 is a diagram for describing a notification example in a case of a left turn (part 1).

FIG. 41 is a diagram for describing the notification example in the case of the left turn (part 2).

FIG. 42 is a diagram illustrating changes in display at the time of loss according to an embodiment of the present disclosure.

FIG. 43 is a flowchart illustrating an example of an operation flow of changing the display direction over time according to an embodiment of the present disclosure.

FIG. 44 is a diagram for describing a detailed flow example of an automatic operation mode according to an embodiment of the present disclosure.

FIG. 45 is a diagram for describing a detailed flow example of a user operation mode according to an embodiment of the present disclosure.

FIG. 46 is a diagram for describing a detailed flow example of an event presentation mode according to an embodiment of the present disclosure.

FIG. 47 is a diagram for describing a configuration for changing a notification method of an acoustic event on the basis of an onboard conversation according to an embodiment of the present disclosure.

FIG. 48 is a flowchart illustrating an operation example when a notification method for an acoustic event is changed on the basis of an onboard conversation according to an embodiment of the present disclosure.

FIG. 49 is a diagram illustrating an example of elements used when it is determined whether or not an acoustic event extracted from the onboard conversation in step S403 of FIG. 48 is related to an acoustic event.

FIG. 50 is a hardware configuration diagram illustrating an example of a computer that implements functions of units according to the present disclosure.

### DESCRIPTION OF EMBODIMENTS

Hereinafter, embodiments of the present disclosure will be described in detail on the basis of the drawings. Note that in each of the following embodiments, the same parts are denoted by the same symbols, and redundant description will be omitted.

The present disclosure will be described in the following order of items.
1. Embodiment
1.1 Configuration Example of Vehicle Control System
1.2 Schematic Configuration Example of Acoustic Control Device
1.3 Exemplary Cases Where Sound Information Is Important
1.4 Examples of Exterior Microphones
1.5 Arrangement Examples of Exterior Microphones
1.6 Examples of Audio Signal Processing
1.6.1 Detection of Sound Direction
1.6.2 Beamforming (Correction)
1.6.3 Sound Direction Tracking
1.7 Improvement in Detection Accuracy of Sound Direction
1.8 Acoustic Event Specifying Method
1.9 Examples of Display Application
1.9.1 First Display Example
1.9.2 Second Display Example
1.9.3 Third Display Example
1.9.4 Fourth Display Example
1.9.5 Fifth Display Example
1.10 Application Example of Display Application
1.11 Detection Notification of Emergency Vehicle
1.12 Notification Priorities
1.13 Examples of Notification Operation with Regards to Emergency Vehicle
1.14 Exemplary Flow of Notification Operation Regarding Emergency Vehicle
1.15 Example of Notification Method in Multi-speaker Environment
1.16 Cooperation with Other Sensors
1.17 Log Recording
1.18 Change Over Time in Display Direction
1.19 Exemplary Operation Flow of Change Over Time in Display Direction
1.20 Operation Mode Examples
1.20.1 Automatic Operation Mode
1.20.2 User Operation Mode
1.20.3 Event Presentation Mode
1.21 Notification Method for Acoustic Event Utilizing Onboard Conversation
1.21.1 Configuration Example
1.21.2 Operation Example
1.21.3 Exemplary Elements Used for Keyword Determination
2. Hardware Configuration

### 1. Embodiment

Hereinafter, an embodiment according to the present disclosure will be described in detail with reference to the drawings.

### 1.1 Configuration Example of Vehicle Control System

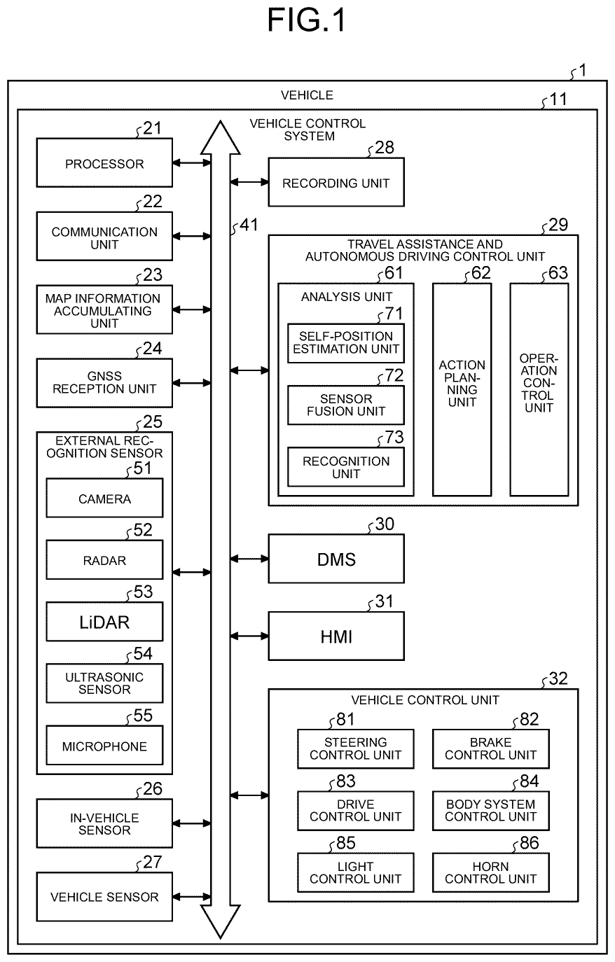

First, a moving device control system according to the present embodiment will be described. FIG. 1 is a block diagram illustrating a configuration example of a vehicle control system 11 as an example of the moving device control system according to the present embodiment.

The vehicle control system 11 is included in a vehicle 1 and performs processing related to travel assistance and autonomous driving of the vehicle 1. Note that the vehicle control system 11 is not limited to a vehicle that travels on the ground or the like and may be mounted on a moving body that can travel in a three-dimensional space such as in the air or under water.

The vehicle control system 11 includes a vehicle control electronic control unit (ECU) (hereinafter, also referred to as a processor)21, a communication unit 22, a map information accumulating unit 23, a global navigation satellite system (GNSS) reception unit 24, an external recognition sensor 25, an in-vehicle sensor 26, a vehicle sensor 27, a recording unit 28, a travel assistance and autonomous driving control unit 29, a driver monitoring system (DMS) 30, a human machine interface (HMI) 31, and a vehicle control unit 32.

The vehicle control ECU 21, the communication unit 22, the map information accumulating unit 23, the GNSS reception unit 24, the external recognition sensor 25, the in-vehicle sensor 26, the vehicle sensor 27, the recording unit 28, the travel assistance and autonomous driving control unit 29, the DMS 30, the HMI 31, and the vehicle control unit 32 are communicably connected to each other via a communication network 41. The communication network 41 includes, for example, an in-vehicle communication network conforming to digital bilateral communication standards, such as a controller area network (CAN), a local interconnect network (LIN), a local area network (LAN), FlexRay (registered trademark), or Ethernet (registered trademark), a bus, or the like. The communication network 41 may be selectively used depending on the type of data to be communicated. For example, CAN is applied to data related to vehicle control, and Ethernet is applied to large-capacity data. Note that each unit of the vehicle control system 11 may be directly connected, not via the communication network 41, but by using wireless communication based on the premise of communication at a relatively short distance, such as near field communication (NFC) or Bluetooth (registered trademark).

Note that, hereinafter, in a case where each unit of the vehicle control system 11 performs communication via the communication network 41, description of the communication network 41 will be omitted. For example, in a case where the vehicle control ECU 21 and the communication unit 22 perform communication via the communication network 41, it is simply described that the processor 21 and the communication unit 22 perform communication.

The vehicle control ECU 21 includes, for example, various processors such as a central processing unit (CPU) or a micro processing unit (MPU). The vehicle control ECU 21 controls all or some of functions of the vehicle control system 11.

The communication unit 22 communicates with various devices inside and outside the vehicle, other vehicles, servers, base stations, and the like and transmits and receives various types of data. At this point, the communication unit 22 can perform communication using a plurality of communication schemes.

Communication that the communication unit 22 can execute with the outside of the vehicle will be schematically described. The communication unit 22 communicates with a server (hereinafter, referred to as an external server) or the like on an external network via a base station or an access point by a wireless communication scheme such as the 5th generation mobile communication system (5G), long term evolution (LTE), or dedicated short range communications (DSRC). The external network with which the communication unit 22 communicates is, for example, the Internet, a cloud network, a network unique to a company, or the like. The communication scheme used for performing communication with the external network by the communication unit 22 is not particularly limited as long as it is a wireless communication scheme capable of performing digital bidirectional communication at a communication speed equal to or higher than a predetermined speed and at a distance equal to or longer than a predetermined distance.

Furthermore, for example, the communication unit 22 can communicate with a terminal present in the vicinity of the host vehicle using peer to peer (P2P) technology. The terminal present in the vicinity of the host vehicle is, for example, a terminal worn by a moving body traveling at a relatively low speed such as a pedestrian or a bicycle, a terminal installed in a store or the like with a position fixed, or a machine type communication (MTC) terminal. Furthermore, the communication unit 22 can also perform V2X communication. The V2X communication refers to communication between the host vehicle and another party, such as vehicle to vehicle communication with another vehicle, vehicle to infrastructure communication with a roadside device or the like, vehicle to home communication with a house, and vehicle to pedestrian communication with a terminal or the like carried by a pedestrian.

The communication unit 22 can receive, for example, a program for updating software for controlling the operation of the vehicle control system 11 from the outside (Over-the-Air). The communication unit 22 can further receive map information, traffic information, information of the surroundings of the vehicle 1, and others from the outside. Furthermore, for example, the communication unit 22 can transmit information regarding the vehicle 1, information of the surroundings of the vehicle 1, and others to the outside. Examples of the information of the vehicle 1 transmitted to the outside by the communication unit 22 include data indicating the state of the vehicle 1, a recognition result by a recognition unit 73, and others. Furthermore, for example, the communication unit 22 performs communication conforming to a vehicle emergency call system such as the eCall.

Communication that the communication unit 22 can execute with the inside of the vehicle will be schematically described. The communication unit 22 can communicate with each device in the vehicle using, for example, wireless communication. The communication unit 22 can perform wireless communication with an in-vehicle device by a communication scheme capable of performing digital bidirectional communication at a communication speed equal to or higher than a predetermined speed by wireless communication, such as wireless LAN, Bluetooth, NFC, or wireless USB (WUSB). Without being limited to the above, the communication unit 22 can also communicate with each device in the vehicle using wired communication. For example, the communication unit 22 can communicate with each device in the vehicle by wired communication via a cable connected to a connection terminal (not illustrated). The communication unit 22 can communicate with each device in the vehicle by a communication scheme capable of performing digital bidirectional communication at a predetermined communication speed or higher by wired communication, such as the universal serial bus (USB), high-definition multimedia interface (HDMI) (registered trademark), or mobile high-definition link (MHL).

Here, a device in the vehicle refers to, for example, a device that is not connected to the communication network 41 in the vehicle. As examples of the device in the vehicle, a mobile device or a wearable device carried by a passenger such as a driver, an information device brought into the vehicle and temporarily installed, or the like are conceivable.

For example, the communication unit 22 receives an electromagnetic wave transmitted by the vehicle information and communication system (VICS) (registered trademark) such as a radio wave beacon, an optical beacon, or FM multiplex broadcasting.

The map information accumulating unit 23 accumulates one or both of a map acquired from the outside and a map created in the vehicle 1. For example, the map information accumulating unit 23 accumulates three-dimensional high-precision maps, a global map having lower accuracy than the high-precision maps but covering a wide area, and others.

The high-precision maps are, for example, dynamic maps, point cloud maps, vector maps, or others. The dynamic map is, for example, a map including four layers of dynamic information, semi-dynamic information, semi-static information, and static information and is provided to the vehicle 1 from an external server or the like. The point cloud map is a map including point clouds (point cloud data). Incidentally, the vector map refers to a map adapted to an advanced driver assistance system (ADAS) in which traffic information such as a lane and a signal position is associated with a point cloud map.

The point cloud map and the vector map may be provided from, for example, an external server or the like or may be created in the vehicle 1 as a map for performing matching with a local map to be described later on the basis of a sensing result by a radar 52, a LiDAR 53, or the like and accumulated in the map information accumulating unit 23. In addition, in a case where a high-precision map is provided from an external server or the like, for example, map data of several hundred meters square regarding a planned path on which the vehicle 1 is about to travel is acquired from an external server or the like in order to reduce the communication capacity.

The GNSS reception unit 24 receives GNSS signals from GNSS satellites and acquires position information of the vehicle 1. Received GNSS signals are supplied to the travel assistance and autonomous driving control unit 29. Note that the GNSS reception unit 24 is not limited to the method using the GNSS signals and may acquire the position information using, for example, a beacon.

The external recognition sensor 25 includes various sensors used for recognition of a situation outside the vehicle 1 and supplies sensor data from each of the sensors to units in the vehicle control system 11. Any type and any number of sensors may be included in the external recognition sensor 25.

For example, the external recognition sensor 25 includes a camera 51 (also referred to as an exterior camera), the radar 52, the light detection and ranging or laser imaging detection and ranging (LiDAR) 53, an ultrasonic sensor 54, and a microphone 55. Without being limited to the above, the external recognition sensor 25 may include one or more types of sensors among the camera 51, the radar 52, the LiDAR 53, and the ultrasonic sensor 54. The numbers of cameras 51, radars 52, LiDARs 53, ultrasonic sensors 54, and the microphones 55 are not particularly limited as long as they can be practically installed in the vehicle 1. Furthermore, the type of sensor included in the external recognition sensor 25 is not limited to this example, and the external recognition sensor 25 may include another type of sensor. Examples of the sensing area of each sensor included in the external recognition sensor 25 will be described later.

Note that the imaging method of the camera 51 is not particularly limited as long as it is an imaging method capable of ranging. For example, cameras of various imaging methods such as a time-of-flight (ToF) camera, a stereo camera, a monocular camera, and an infrared camera can be applied to the camera 51, as necessary. Without being limited to the above, the camera 51 may simply acquire a captured image regardless of ranging.

Furthermore, for example, the external recognition sensor 25 can include an environment sensor for detecting the environment for the vehicle 1. The environment sensor is a sensor for detecting an environment such as the weather, the climate, or the brightness and can include various sensors such as a raindrop sensor, a fog sensor, a sunshine sensor, a snow sensor, and an illuminance sensor.

Furthermore, for example, the external recognition sensor 25 includes a microphone used for detecting sound around the vehicle 1 or a position of an object serving as a sound source (hereinafter, also simply referred to as a sound source).

The in-vehicle sensor 26 includes various sensors for detecting information inside the vehicle and supplies sensor data from each sensor to each unit of the vehicle control system 11. The type and the number of various sensors included in the in-vehicle sensor 26 are not particularly limited as long as they can be practically installed in the vehicle 1.

For example, the in-vehicle sensor 26 can include one or more types of sensors of a camera, a radar, a seating sensor, a steering wheel sensor, a microphone, and a biological sensor. As the camera included in the in-vehicle sensor 26, for example, cameras of various imaging methods capable of ranging, such as a ToF camera, a stereo camera, a monocular camera, and an infrared camera, can be used. Without being limited to the above, the camera included in the in-vehicle sensor 26 may simply acquire a captured image regardless of ranging. The biological sensor included in the in-vehicle sensor 26 is included, for example, on a seat, a steering wheel, or the like and detects various types of biological information of a passenger such as the driver.

The vehicle sensor 27 includes various sensors for detecting the state of the vehicle 1 and supplies sensor data from each sensor to each unit of the vehicle control system 11. The type and the number of various sensors included in the vehicle sensor 27 are not particularly limited as long as they can be practically installed in the vehicle 1.

For example, the vehicle sensor 27 includes a speed sensor, an acceleration sensor, an angular velocity sensor (gyro sensor), and an inertial measurement unit (IMU) integrating these sensors. For example, the vehicle sensor 27 includes a steering angle sensor that detects the steering angle of the steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the number of revolutions of the engine or the motor, an air pressure sensor that detects the air pressure of the tires, a slip rate sensor that detects the slip rate of the tires, and a wheel speed sensor that detects the rotational speed of the wheels. For example, the vehicle sensor 27 includes a battery sensor that detects a remaining amount and the temperature of a battery and an impact sensor that detects an impact from the outside.

The recording unit 28 includes at least one of a nonvolatile storage medium or a volatile storage medium and stores data or a program. The recording unit 28 is used as, for example, an electrically erasable programmable read-only memory (EEPROM) and a random access memory (RAM), and a magnetic storage device such as a hard disc drive (HDD), a semiconductor storage device, an optical storage device, and a magneto-optical storage device can be applied as the storage medium. The recording unit 28 records various programs and data used by each unit of the vehicle control system 11. For example, the recording unit 28 includes an event data recorder (EDR) or a data storage system for automated driving (DSSAD) and records information of the vehicle 1 before and after an event such as an accident and biological information acquired by the in-vehicle sensor 26.

The travel assistance and autonomous driving control unit 29 controls travel assistance and autonomous driving of the vehicle 1. For example, the travel assistance and autonomous driving control unit 29 includes an analysis unit 61, an action planning unit 62, and an operation control unit 63.

The analysis unit 61 performs analysis processing of the situation of the vehicle 1 and the surroundings. The analysis unit 61 includes a self-position estimation unit 71, a sensor fusion unit 72, and the recognition unit 73.

The self-position estimation unit 71 estimates the self-position of the vehicle 1 on the basis of the sensor data from the external recognition sensor 25 and the high-precision maps accumulated in the map information accumulating unit 23. For example, the self-position estimation unit 71 generates a local map on the basis of the sensor data from the external recognition sensor 25 and estimates the self-position of the vehicle 1 by matching the local map with the high-precision maps. The position of the vehicle 1 is based on, for example, the center of the axle of the pair of rear wheels.

The local map is, for example, a three-dimensional high-precision map created using technology such as simultaneous localization and mapping (SLAM), an occupancy grid map, or the like. The three-dimensional high-precision map is, for example, the above-described point cloud map or the like. The occupancy grid map is a map in which a three-dimensional or two-dimensional space around the vehicle 1 is divided into grids of a predetermined size, and an occupancy state of an object is indicated for every grid. The occupancy state of the object is indicated by, for example, the presence or absence or the presence probability of the object. The local map is also used for detection processing and recognition processing of a situation outside the vehicle 1 by the recognition unit 73, for example.

Note that the self-position estimation unit 71 may estimate the self-position of the vehicle 1 on the basis of the GNSS signals and the sensor data from the vehicle sensor 27.

The sensor fusion unit 72 performs sensor fusion processing of combining a plurality of different types of sensor data (for example, image data supplied from the camera 51 and sensor data supplied from the radar 52) to obtain new information. Methods for combining different types of sensor data include integration, fusion, association, and the like.

The recognition unit 73 executes detection processing for detecting the situation outside the vehicle 1 and recognition processing for recognizing the situation outside the vehicle 1.

For example, the recognition unit 73 performs the detection processing and the recognition processing of the situation outside the vehicle 1 on the basis of information from the external recognition sensor 25, information from the self-position estimation unit 71, information from the sensor fusion unit 72, and others.

Specifically, for example, the recognition unit 73 performs the detection processing, the recognition processing, and others of an object around the vehicle 1. The detection processing of an object is, for example, processing of detecting the presence or absence, the size, the shape, the position, the motion, and the like of the object. The recognition processing of an object is, for example, processing of recognizing an attribute such as the type of the object or identifying a specific object. However, the detection processing and the recognition processing are not necessarily clearly divided but may overlap with each other.

For example, the recognition unit 73 detects an object around the vehicle 1 by performing clustering of classifying point clouds based on sensor data by the radar 52, the LiDAR 53, the ultrasonic sensor 54, or the like into groups of point clouds. As a result, the presence or absence, the size, the shape, and the position of an object around the vehicle 1 are detected.

For example, the recognition unit 73 detects the motion of an object around the vehicle 1 by performing tracking of following the motion of a group of point clouds classified by the clustering. As a result, the speed and the traveling direction (travel vector) of the object around the vehicle 1 are detected.

For example, the recognition unit 73 detects or recognizes a vehicle, a person, a bicycle, an obstacle, a structure, a road, a traffic light, a traffic sign, road marking, and the like from image data supplied from the camera 51. Furthermore, the type of the object around the vehicle 1 may be recognize by performing recognition processing such as semantic segmentation.

For example, the recognition unit 73 can perform recognition processing of traffic rules around the vehicle 1 on the basis of the maps accumulated in the map information accumulating unit 23, an estimation result of the self-position by the self-position estimation unit 71, and a recognition result of the object around the vehicle 1 by the recognition unit 73. Through this processing, the recognition unit 73 can recognize the position and the state of the traffic light, the content of the traffic sign and the road marking, the content of the traffic regulations, travelable lanes, and the like.

For example, the recognition unit 73 can perform the recognition processing of the environment around the vehicle 1. As the surrounding environment to be recognized by the recognition unit 73, the weather, the temperature, the humidity, the brightness, the state of a road surface, and the like are conceivable.

For example, the recognition unit 73 performs detection of an acoustic event and executes recognition processing of a distance to a sound source, a direction of the sound source, a relative position with the sound source, and the like on sound data supplied from the microphone 55. Furthermore, the recognition unit 73 executes various types of processing such as determination of the notification priority of the detected acoustic event, detection of a line-of-sight direction of the driver, and speech recognition for recognizing a conversation in the vehicle. Note that, in addition to the sound data supplied from the microphone 55, image data supplied from the camera 51, sensor data by the radar 52, the LiDAR 53, the ultrasonic sensor 54, or the like may be used for these pieces of processing executed by the recognition unit 73.

The action planning unit 62 creates an action plan of the vehicle 1. For example, the action planning unit 62 creates an action plan by performing processing of global path planning and path tracking.

Note that the global path planning is processing of planning a rough path from the start to the goal. This global path planning also includes processing, referred to as local path planning, of local path planning that enables safe and smooth traveling in the vicinity of the vehicle 1 in consideration of the motion characteristics of the vehicle 1 on a path planned in the global path planning. The global path planning may be distinguished as long-term path planning, and local path planning may be distinguished as short-term path planning. A safety-first path represents a concept similar to that of the local path planning or the short-term path planning.

The path tracking is processing of planning an operation for safely and accurately traveling on the path planned by the global path planning within a planned time. For example, the action planning unit 62 can calculate a target speed and a target angular velocity of the vehicle 1 on the basis of the result of the path tracking processing.

The operation control unit 63 controls the operation of the vehicle 1 in order to implement the action plan created by the action planning unit 62.

For example, the operation control unit 63 controls a steering control unit 81, a brake control unit 82, and a drive control unit 83 included in the vehicle control unit 32, to be described later, to perform acceleration and deceleration control and direction control in such a manner that the vehicle 1 travels on the path calculated by the local path planning. For example, the operation control unit 63 performs cooperative control for the purpose of implementing the functions of the ADAS such as collision avoidance or impact mitigation, follow-up traveling, vehicle speed maintaining traveling, collision warning for the host vehicle, lane deviation warning for the host vehicle, and the like. The operation control unit 63 performs, for example, cooperative control for the purpose of autonomous driving or the like in which the vehicle travels autonomously without depending on the operation of the driver.

The DMS 30 performs authentication processing of the driver, recognition processing of the state of the driver, and the like on the basis of sensor data from the in-vehicle sensor 26, input data input to the HMI 31 to be described later, and others. As the state of the driver to be recognized by the DMS 30, for example, the physical condition, the arousal level, the concentration level, the fatigue level, the line-of-sight direction, the drunkenness level, a driving operation, the posture, and the like are conceivable.

Note that the DMS 30 may perform authentication processing of a passenger other than the driver and recognition processing of the state of the passenger. Furthermore, for example, the DMS 30 may perform recognition processing of the situation inside the vehicle on the basis of the sensor data from the in-vehicle sensor 26. As the situation inside the vehicle to be recognized, for example, the temperature, the humidity, the brightness, the odor, and the like are conceivable.

The HMI 31 inputs various types of data, instructions, and the like and presents the various types of data to the driver and others.

Data input by the HMI 31 will be schematically described. The HMI 31 includes an input device for a person to input data. The HMI 31 generates an input signal on the basis of data, an instruction, or the like input by the input device and supplies the input signal to each unit of the vehicle control system 11. The HMI 31 includes an operator such as a touch panel, a button, a switch, or a lever as the input device. Without being limited to the above, the HMI 31 may further include an input device capable of inputting information by a method other than manual operation such as by voice, a gesture, or others. Furthermore, the HMI 31 may use, for example, a remote control device using infrared rays or radio waves or an external connection device such as a mobile device or a wearable device supporting the operation of the vehicle control system 11 as the input device.

Presentation of data by the HMI 31 will be schematically described. The HMI 31 generates visual information, auditory information, and tactile information for the passengers or the outside of the vehicle. In addition, the HMI 31 performs output control for controlling output, output content, output timing, an output method, and others of each piece of information that is generated. The HMI 31 generates and outputs, as the visual information, information indicated by images or light such as an operation screen, state display of the vehicle 1, warning display, or a monitor image indicating a situation around the vehicle 1. Furthermore, the HMI 31 generates and outputs information indicated by sound such as a voice guidance, an alarm, or a warning message as the auditory information. Furthermore, the HMI 31 generates and outputs, as the tactile information, information given to the tactile sense of the passenger by, for example, a force, vibration, a motion, or the like.

As an output device with which the HMI 31 outputs the visual information, for example, a display device that presents the visual information by displaying an image thereon or a projector device that presents the visual information by projecting an image are applicable. Note that the display device may be a device that displays the visual information in the field of view of the passenger such as a head-up display, a transmissive display, or a wearable device having an augmented reality (AR) function other than a display device having a normal display. In addition, the HMI 31 can use display devices included in a navigation device, an instrument panel, a camera monitoring system (CMS), an electronic mirror, a lamp, or the like included in the vehicle 1 as an output device that outputs the visual information.

As an output device from which the HMI 31 outputs the auditory information, for example, an audio speaker, headphones, or earphones are applicable.

As an output device to which the HMI 31 outputs the tactile information, for example, a haptics element using haptic technology is applicable. The haptics element is provided, for example, at a portion with which a passenger of the vehicle 1 comes into contact, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 detects and controls the state of the steering system of the vehicle 1. The steering system includes, for example, a steering mechanism including a steering wheel and the like, an electric power steering, and the like. The steering control unit 81 includes, for example, a control unit such as an ECU that controls the steering system, an actuator that drives the steering system, and others.

The brake control unit 82 detects and controls the state of the brake system of the vehicle 1. The brake system includes, for example, a brake mechanism including a brake pedal, an antilock brake system (ABS), a regenerative brake mechanism, and the like. The brake control unit 82 includes, for example, a control unit such as an ECU that controls the brake system.

The drive control unit 83 detects and controls the state of a drive system of the vehicle 1. The drive system includes, for example, a driving force generation device for generating a driving force such as an accelerator pedal, an internal combustion engine, and a driving motor, a driving force transmission mechanism for transmitting the driving force to the wheels, and others. The drive control unit 83 includes, for example, a control unit such as an ECU that controls the drive system.

The body system control unit 84 detects and controls the state of a body system of the vehicle 1. The body system includes, for example, a keyless entry system, a smart key system, a power window device, a power seat, an air conditioner, an airbag, a seat belt, a shift lever, and others. The body system control unit 84 includes, for example, a control unit such as an ECU that controls the body system.

The light control unit 85 detects and controls states of various lights of the vehicle 1. As the lights to be controlled, for example, a headlight, a backlight, a fog light, a turn signal, a brake light, projection, display on a bumper, and the like are conceivable. The light control unit 85 includes a control unit such as an ECU that controls the lights.

The horn control unit 86 detects and controls the state of a car horn of the vehicle 1. The horn control unit 86 includes, for example, a control unit such as an ECU that controls the car horn.

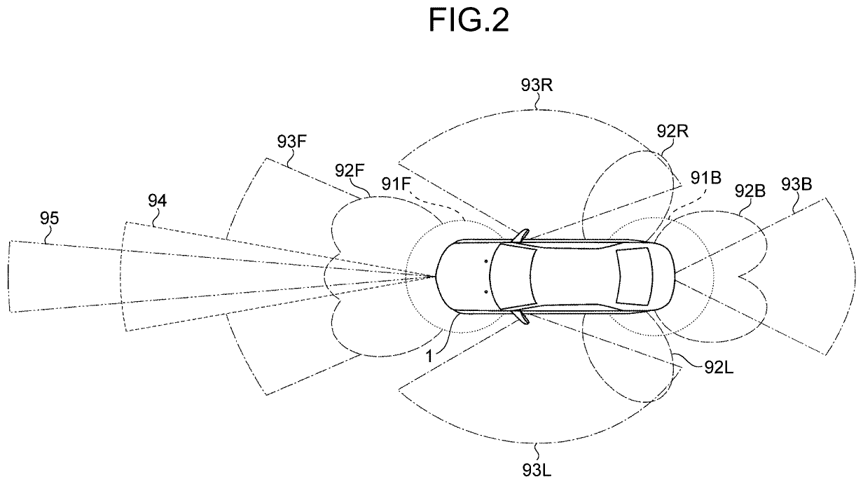

FIG. 2 is a diagram illustrating an example of sensing areas by the camera 51, the radar 52, the LiDAR 53, the ultrasonic sensor 54, and others of the external recognition sensor 25 in FIG. 1. Note that FIG. 2 schematically illustrates the vehicle 1 as viewed from above, in which the left end side is the front end (front) side of the vehicle 1, and the right end side is the rear end (rear) side of the vehicle 1.

A sensing area 91F and a sensing area 91B indicate examples of sensing areas of ultrasonic sensors 54. The sensing area 91F covers the periphery of the front end of the vehicle 1 by a plurality of ultrasonic sensors 54. The sensing area 91B covers the periphery of the rear end of the vehicle 1 by a plurality of ultrasonic sensors 54.

Sensing results in the sensing area 91F and the sensing area 91B are used for, for example, parking assistance or the like of the vehicle 1.

A sensing area 92F or a sensing area 92B indicates an example of a sensing area of the radar 52 for a short distance or a middle distance. The sensing area 92F covers up to a position farther than the sensing area 91F ahead of the vehicle 1. The sensing area 92B covers up to a position farther than the sensing area 91B behind the vehicle 1. A sensing area 92L covers the rear periphery of the left side face of the vehicle 1. A sensing area 92R covers the rear periphery of the right side face of the vehicle 1.

A sensing result in the sensing area 92F is used for, for example, detecting a vehicle, a pedestrian, or the like present ahead of the vehicle 1. A sensing result in the sensing area 92B is used for, for example, a collision prevention function or the like behind the vehicle 1. Sensing results in the sensing area 92L and the sensing area 92R are used for, for example, detecting an object in a blind spot on the sides of the vehicle 1.

A sensing area 93F or a sensing area 93B indicates an example of a sensing area by the camera 51. The sensing area 93F covers up to a position farther than the sensing area 92F ahead of the vehicle 1. The sensing area 93B covers up to a position farther than the sensing area 92B behind the vehicle 1. A sensing area 93L covers the periphery of the left side face of the vehicle 1. A sensing area 93R covers the periphery of the right side face of the vehicle 1.

A sensing result in the sensing area 93F can be used for, for example, recognition of a traffic light or a traffic sign, a lane deviation prevention assist system, and an automatic headlight control system. A sensing result in the sensing area 93B can be used for, for example, parking assistance and a surround view system. Sensing results in the sensing area 93L and the sensing area 93R can be used for the surround view system, for example.

A sensing area 94 indicates an example of a sensing area of the LiDAR 53. The sensing area 94 covers up to a position farther than the sensing area 93F ahead of the vehicle 1. Meanwhile, the sensing area 94 has a narrower area in the left-right direction than that of the sensing area 93F.

A sensing result in the sensing area 94 is used for, for example, detecting an object such as a surrounding vehicle.

A sensing area 95 indicates an example of a sensing area of the radar 52 for a long distance. The sensing area 95 covers up to a position farther than the sensing area 94 ahead of the vehicle 1. Meanwhile, the sensing area 95 has a narrower area in the left-right direction than that of the sensing area 94.

A sensing result in the sensing area 95 is used for, for example, adaptive cruise control (ACC), emergency braking, collision avoidance, and the like.

Note that the sensing areas of the sensors of the camera 51, the radar 52, the LiDAR 53, and the ultrasonic sensors 54 included in the external recognition sensor 25 may have various configurations other than that in FIG. 2. Specifically, the ultrasonic sensors 54 may also perform sensing on the sides of the vehicle 1, or the LiDAR 53 may perform sensing behind the vehicle 1. In addition, the installation positions of the sensors are not limited to the examples described above. Furthermore, the number of the sensors may be one or plural.

### 1.2 Schematic Configuration Example of Acoustic Control Device

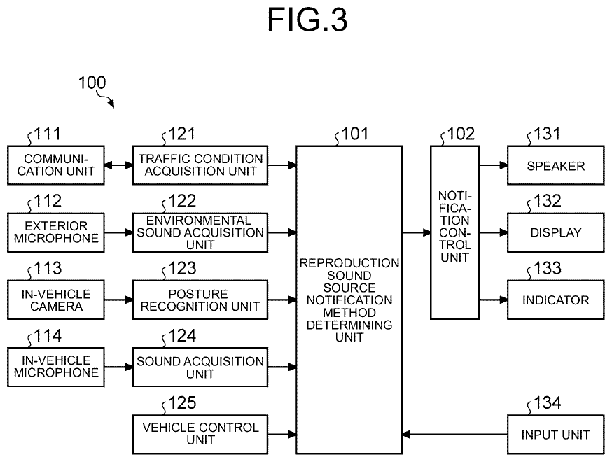

Next, a schematic configuration example of an acoustic control device according to the present embodiment will be described in detail with reference to the drawings. FIG. 3 is a block diagram illustrating a schematic configuration example of the acoustic control device according to the present embodiment.

As illustrated in FIG. 3, the acoustic control device 100 can include a communication unit 111, an exterior microphone 112, an in-vehicle camera 113, an in-vehicle microphone 114, a traffic condition acquisition unit 121, an environmental sound acquisition unit 122, a posture recognition unit 123, a sound acquisition unit 124, a vehicle control unit 125, a reproduction sound source notification method determining unit 101, a notification control unit 102, a speaker 131, a display 132, an indicator 133, and an input unit 134. Among them, the communication unit 111 may correspond to the communication unit 22 in FIG. 1, the exterior microphone 112 may correspond to the microphone 55 in FIG. 1, the in-vehicle camera 113 and the in-vehicle microphone 114 may be included in the in-vehicle sensor 26 in FIG. 1, the traffic condition acquisition unit 121, the environmental sound acquisition unit 122, the sound acquisition unit 124, the reproduction sound source notification method determining unit 101, and the notification control unit 102 may be included in the travel assistance and autonomous driving control unit 29 in FIG. 1, the posture recognition unit 123 may correspond to the DMS 30 in FIG. 1, and the vehicle control unit 125 may correspond to the vehicle control unit 32 in FIG. 1. However, it is not limited thereto, and for example, at least one of the reproduction sound source notification method determining unit 101, the notification control unit 102, and the posture recognition unit 123 may be disposed in another information processing device that is mounted on the vehicle 1 and connected with the vehicle control system 11 via a controller area network (CAN), a server (including a cloud server), or the like that is disposed on a network outside the vehicle to which the acoustic control device 100 and/or the vehicle control system 11 can be connected via the communication unit 111 and/or the communication unit 22, such as the Internet.

### (Traffic Condition Acquisition Unit 121)

As described above, the traffic condition acquisition unit 121 acquires map information, traffic information, information around the vehicle 1, and the like (hereinafter, also referred to as traffic condition information) via the communication unit 111. The acquired traffic condition information is input to the reproduction sound source notification method determining unit 101. Note that, in a case where the reproduction sound source notification method determining unit 101 is disposed on a network outside the vehicle, the traffic condition acquisition unit 121 may transmit the traffic condition information to the reproduction sound source notification method determining unit 101 via the communication unit 111. This may be similarly applied to the environmental sound acquisition unit 122, the posture recognition unit 123, the sound acquisition unit 124, the vehicle control unit 125, and the like described below.

### (Environmental Sound Acquisition Unit 122)

The environmental sound acquisition unit 122 acquires sound data (hereinafter, also referred to as environmental sound data) indicating the environmental sound outside the vehicle by inputting an audio signal from the exterior microphone 112, which is attached to the vehicle 1 and collects the environmental sound outside the vehicle, and converting the audio signal into a digital signal. The acquired environmental sound data is input to the reproduction sound source notification method determining unit 101.

### (Posture Recognition Unit 123)

The posture recognition unit 123 inputs image data of a driver or a passenger (user) captured by the in-vehicle camera 113, which is attached to the vehicle 1 and captures an image of the driver's seat, and analyzes the input image data to detect information such as the posture and the line-of-sight direction of the user (hereinafter, referred to as posture information). The detected posture information is input to the reproduction sound source notification method determining unit 101.

### (Sound Acquisition Unit 124)

The sound acquisition unit 124 acquires sound data indicating the sound in the vehicle (hereinafter, also referred to as onboard sound data) by inputting an audio signal from the in-vehicle microphone 114 that is attached to vehicle 1 and collects sound such as a conversation in the vehicle and converting the audio signal into a digital signal. The acquired onboard sound data is input to the reproduction sound source notification method determining unit 101.

### (Reproduction Sound Source Notification Method Determining Unit 101)

As described above, the traffic condition information is input from the traffic condition acquisition unit 121, the environmental sound data is input from the environmental sound acquisition unit 122, the posture information is input from the posture recognition unit 123, and the onboard sound data is input from the sound acquisition unit 124 to the reproduction sound source notification method determining unit 101. Furthermore, operation information of the steering wheel, the brake pedal, the blinker, or others is input from the vehicle control unit 125 to the reproduction sound source notification method determining unit 101. Note that the operation information may include information such as the speed, the acceleration, the angular velocity, or the angular acceleration of the vehicle 1.

The reproduction sound source notification method determining unit 101 executes various types of processing such as detection of an acoustic event, recognition of a distance to a sound source, recognition of a direction of the sound source, recognition of a relative position with respect to the sound source, determination of a notification priority, posture information detection, and onboard conversation recognition by using at least one piece of the input information.

### (Notification Control Unit 102)

The notification control unit 102 controls reproduction of the environmental sound around the vehicle 1 and notification of metadata regarding an object, a building, or the like (hereinafter, collectively referred to as objects) around the vehicle 1 to the user by complying with an instruction from the reproduction sound source notification method determining unit 101. Note that the objects may include a moving body such as another vehicle or a person, a fixed object such as a signboard or a sign, and others. Furthermore, a facility may include various facilities such as a park, a kindergarten, an elementary school, a convenience store, a supermarket, a station, or a city hall. Meanwhile, the metadata notified to the user may be an audio signal (namely, sound) or may be information such as an object type, an object direction, or the distance to an object.

The speaker 131 may be used to reproduce the environmental sound. In addition, the display 132 or the speaker 131 may be used to notify of the object. In addition, for reproduction of the environmental sound and notification of an object, the indicator 133, a light emitting diode (LED) light, or the like included on the instrument panel or the like of the vehicle 1 may be used.

### (Input Unit 134)

The input unit 134 includes, for example, a touch panel superimposed on a screen of the display 132, buttons included on the instrument panel (for example, a center cluster), a console, or the like of the vehicle 1, and the user inputs various operations depending on information notified under the control of the notification control unit 102. The input operation information is input to the reproduction sound source notification method determining unit 101. The reproduction sound source notification method determining unit 101 controls and adjusts the reproduction of the environmental sound, the notification of objects, and the like on the basis of the operation information input from the user.

1.3 Exemplary Cases where Sound Information is Important

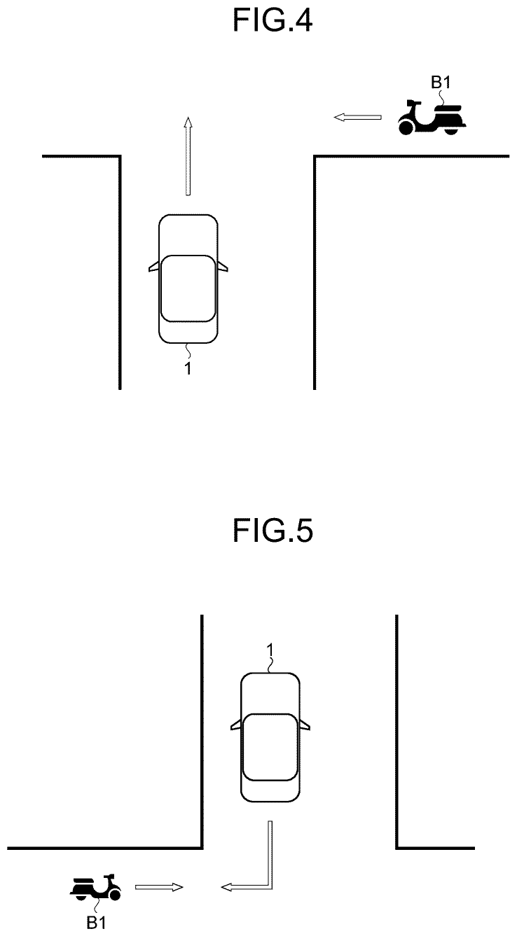

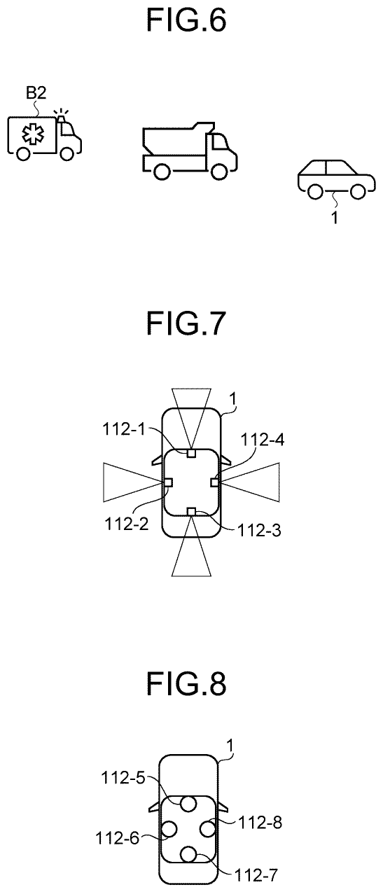

In autonomous driving and driving assistance, it is important to quickly and accurately notify the driver of the situation around the vehicle 1. For example, although it is possible to grasp the situation around the vehicle 1 to some extent by analyzing the image data acquired by the camera 51 attached to the vehicle 1 or the sensor data acquired by the radar 52, the LiDAR 53, or the ultrasonic sensor 54, it is difficult to recognize a target object with the image data or the sensor data described above, for example, in a case where a moving body B1 such as a motorcycle or an automobile is approaching from a blind spot due to an obstacle such as a wall at an intersection or the like as illustrated in FIG. 4, a case where a moving body B1 such as a motorcycle or an automobile is approaching from a blind spot due to an obstacle such as a wall at a time of traveling backward from a garage or the like to a road as illustrated in FIG. 5, or a case where an emergency vehicle B2 is approaching from a blind spot due to a truck or the like as illustrated in FIG. 6.

Meanwhile, a moving body or an emergency vehicle that is traveling emits specific sound such as a traveling sound or a siren. Therefore, in such cases as described above, it is possible to recognize an object that is difficult to detect by the camera 51, the radar 52, the LiDAR 53, or the ultrasonic sensor 54 by referring to the environmental sound acquired by the exterior microphone 112. As described above, by recognizing the objects around the vehicle 1 on the basis of the environmental sound, even in a case where it is difficult to avoid danger such as collision at the time of detection by the camera 51, the radar 52, the LiDAR 53, or the ultrasonic sensor 54, it is possible to notify the user of the presence of an object or danger in advance, and thus, it is possible to suppress deterioration in driving safety.

For example, reproducing the traveling sound of the moving body B1, the siren of the emergency vehicle B2, and the like present in a blind spot by the speaker 131 in the vehicle 1 makes it possible to notify the user of the presence or approach of these objects. At this point, in a case where music, a radio program, or the like is reproduced in the vehicle 1, it is possible to reduce the occurrence of a situation in which the user does not notice the presence or the approach by reducing the volume of the music, the radio program, or the like or increasing the volume of the traveling sound of the moving body B1, the siren of the emergency vehicle B2, or the like for reproduction, whereby it is possible to further suppress deterioration in driving safety.

Furthermore, in a case where the positional relationship (distance, direction, or the like) between the vehicle 1 and an object can be specified from environmental sound, traffic condition information, or the like, by visually notifying the user of the positional relationship with the object using the display 132, it is made possible to more accurately notify the user of the situation around the vehicle 1, and thus, it is also possible to further suppress deterioration in driving safety.

### 1.4 Examples of Exterior Microphones

Next, the exterior microphone 112 for acquiring the environmental sound will be described with an example. General microphones include directional microphones that exert high sensitivity to sound from a specific direction and omnidirectional microphones that exert substantially uniform sensitivity to sound from all directions.

In a case where an omnidirectional microphone is adopted as the exterior microphone 112, the number of microphones mounted on the vehicle 1 may be one or more. Meanwhile, in a case where a directional microphone is adopted, as illustrated in FIG. 7, in the vehicle 1, in order to be able to collect sound from all directions as evenly as possible, a plurality of (four in FIG. 7 as an example) directional microphones 112-1 to 112-4 may be arranged in such a manner as to face in directions opposite to the center of the vehicle 1 or the center of the microphone arrangement. FIG. 7 illustrates a case where the four directional microphones 112-1 to 112-4 are arranged to face four directions (front, back, left, and right).

By adopting directional microphones as the exterior microphone 112, it is made possible to specify the direction of an object serving as a sound source with respect to the vehicle 1. However, even in a case where an omnidirectional microphone is adopted, as illustrated in FIG. 8, by regularly arranging a plurality of (four in FIG. 8 as an example) omnidirectional microphones 112-5 to 112-8, it is possible to specify the direction of an object serving as a sound source with respect to the vehicle 1 on the basis of the intensity and a phase difference of the sound detected by each of the omnidirectional microphones 112-5 to 112-8.

The exterior microphone 112 is basically preferably disposed at a position far from a noise generation source (for example, the tires, the engine, or others) in the vehicle 1. However, in a case where the exterior microphone 112 includes a plurality of microphones, at least one of the plurality of microphones may be arranged in the vicinity of the noise generation source in the vehicle 1. By using an audio signal detected by the microphone arranged in the vicinity of the noise generation source, it is possible to reduce a noise component in audio signals (environmental sound data) detected by the other microphones (noise canceling).

### 1.5 Arrangement Examples of Exterior Microphones

Next, the arrangement depending on the purpose of the exterior microphone 112 will be described with some examples. Note that, in the present description, the exterior microphone 112 may be directional microphones or omnidirectional microphones.

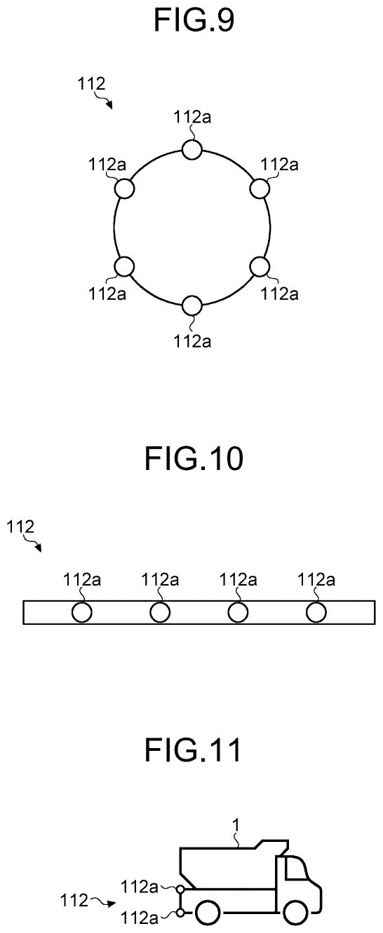

FIG. 9 is a diagram illustrating an arrangement example of exterior microphones in a case of detecting sound from all directions, and FIG. 10 is a diagram illustrating an arrangement example of exterior microphones in a case of detecting sound from a specific direction. Furthermore, FIG. 11 is a diagram illustrating an arrangement example of exterior microphones in a case of detecting sound from a lower tail direction of the vehicle.

As illustrated in FIG. 9, in a case where sound is detected from all directions with respect to the vehicle 1, the exterior microphone 112 may include, for example, a plurality of (for example, six in FIG. 9) microphones 112a arranged at equal intervals along a circle or an ellipse on a horizontal plane.

On the other hand, as illustrated in FIG. 10, in a case where sound from a specific direction such as the front, the rear, a side, or an oblique direction of the vehicle is detected, the exterior microphone 112 may include a plurality of (for example, four in FIG. 10) microphones 112a arranged at equal intervals along a straight line on a horizontal plane. In the case of such an arrangement, the exterior microphone 112 has directivity that exerts high sensitivity to sound from the arrangement direction.

Furthermore, for example, for detecting whether or not an object such as an automobile, a person, or an animal is present at the tail of the vehicle, which is a blind spot when the vehicle travels backward or when a load is unloaded, as illustrated in FIG. 11, the exterior microphone 112 may include a plurality of (for example, two in FIG. 11) microphones 112a arranged along a vertical direction at the tail of the vehicle 1.

In the above arrangement example, for example, in a case where the direction of sound around 1 kilohertz (kHz) is estimated, the microphones 112a may be arranged at intervals of several centimeters in order to increase the detection accuracy with respect to the phase difference of the sound. At this point, the detection accuracy can be further improved by increasing the number of microphones 112a to be arranged.

Furthermore, for example, by arranging the exterior microphone 112 including the plurality of microphones 112a dispersedly in the vehicle 1, it is also possible to improve the detection accuracy of the sound and the detection accuracy of the direction and the distance thereof.

Furthermore, the exterior microphone 112 may be disposed at a position (for example, an upper portion of the body of the vehicle 1 or the like) where it is unlikely to be affected by wind or the like during traveling or at other times in consideration of the exterior shape or others of the vehicle 1. In this case, the exterior microphone 112 may be disposed inside the vehicle 1.

Note that the above-described arrangements of the exterior microphones 112 are merely examples, and various modifications may be made depending on the purpose. Furthermore, the exterior microphone 112 may be configured by combining some of the above-described arrangements and modified arrangement examples.

### 1.6 Examples of Audio Signal Processing

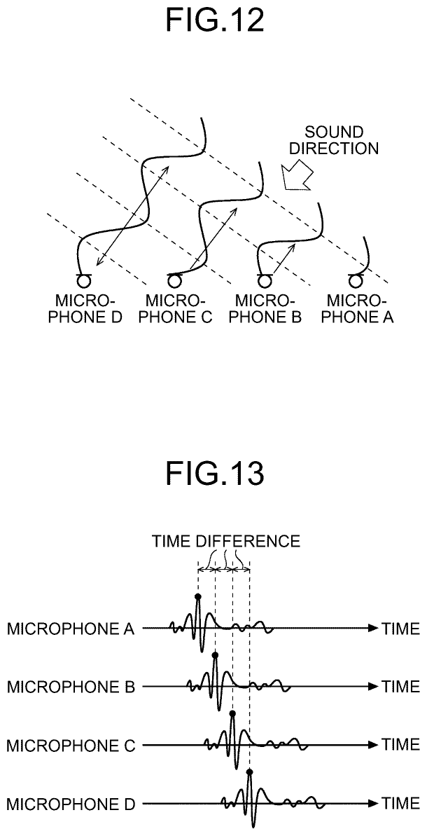

Next, processing on the audio signal detected by the exterior microphone 112 will be described with some examples. FIGS. 12 to 15 are diagrams for explaining examples of processing on the audio signal according to the present embodiment. Note that, in the following, for example, a case where the reproduction sound source notification method determining unit 101 executes processing on the environmental sound data digitized in the environmental sound acquisition unit 122 will be described as an example; however, it is not limited thereto, and the processing may be executed on the sound data before digitization in the environmental sound acquisition unit 122.

### 1.6.1 Detection of Sound Direction

As illustrated in FIG. 12, in a case where the exterior microphone 112 includes a plurality of (four in this example) microphones A to D arranged at equal intervals on a straight line, as illustrated in FIG. 13, the arrival time of sound emitted from one sound source to each of the microphones A to D differs depending on the distance from the sound source to each of the microphones A to D. Therefore, it is possible to detect the direction of the sound (hereinafter, also referred to as a sound direction) by calculating the differences in the arrival time of the sound among the plurality of microphones A to D and searching for an angle θ at which the phases are aligned in the microphones A to D on the basis of the calculated time differences. Note that the sound direction may be a direction of the sound source with respect to the exterior microphone 112 or the vehicle 1. Furthermore, the microphone arrangement of the exterior microphone 112 is not limited to being at equal intervals on a straight line, and various modifications such as a lattice shape or a hexagonal dense lattice shape can be made as long as the mutual positional relationship is known.

### 1.6.2 Beamforming (Correction)

For example, as illustrated in FIG. 13, in a case where the same sound emitted from the same sound source is detected by the plurality of microphones A to D, waveform shapes of audio signals detected by the microphones A to D have substantially the same shape. Therefore, it is possible to emphasize or suppress sound from a sound source in a specific direction by adding or subtracting (beamforming) environmental sound data to or from each other while correcting the environmental sound data in such a manner that the phases of the audio signals detected by the plurality of microphones A to D are aligned (in other words, in such a manner that the phase differences (corresponding to differences in the arrival time to the microphones A to D) are eliminated). This makes it possible to emphasize sound from a sound source with a high priority to be notified to the user, and conversely, it is possible to suppress sound from a sound source with a low priority, whereby it is possible to obtain an effect such as improving the estimation accuracy of an acoustic event.

### 1.6.3 Sound Direction Tracking

In a case where the vehicle 1 is traveling (traveling straight or turning), a case where a sound source is traveling, or a case where the vehicle 1 and the sound source are moving (note that a case where the vehicle 1 and the sound source are traveling at the same speed in the same direction is excluded), the positional relationship between the vehicle 1 and the sound source constantly changes. In such a case, it is necessary to estimate and track the sound direction that is dynamically changing.

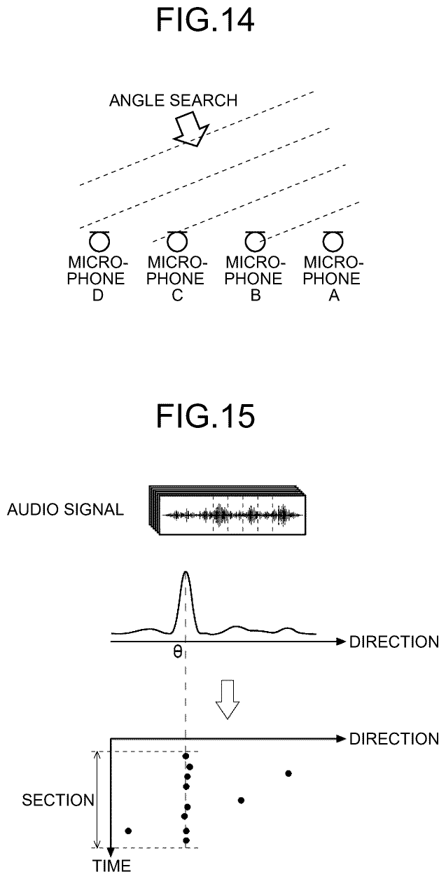

In tracking of a dynamically changing sound direction, for example, as illustrated in FIG. 14, it is presumed that there is a sound source in a certain direction θ, and output of beamforming is calculated in all directions while the phase differences are gradually changed. Then, as illustrated in FIG. 15, the direction θ in which the output of the beamforming reaches its peak is obtained from the calculation result, and this direction θ is obtained as a candidate for the sound direction. Then, by repeating the search of the direction θ as described above at predetermined time intervals, it becomes possible to track the sound direction θ along the time axis.

By executing processing as the above, it is possible to acquire the sound direction from the environmental sound around the vehicle 1. In addition, by tracking the sound direction, it is possible to detect the sound direction by prediction even if the sound is intermittently emitted.

In addition, by performing beamforming on the audio signals (environmental sound data) acquired by the plurality of microphones A to D, it is made possible to acquire clear sound by emphasizing a characteristic sound in a necessary direction, and thus, it is possible to obtain an effect of improving the estimation accuracy of an acoustic event. In addition, in a case where the sound is taken and reproduced inside the vehicle, the sound can be reproduced as sound that is easily recognized by the user.

### 1.7 Improvement in Detection Accuracy of Sound Direction

In a case where the positional relationship between the vehicle 1 and a sound source changes as in a case where the vehicle 1 is traveling, the difficulty in tracking of the sound direction increases. This is because even when the sound direction can be captured, enhanced sound due to beamforming while the direction changes may be distorted due to discontinuous processing. In such a case, when an attempt is made to reproduce the beamformed sound in the vehicle, there is a possibility that the quality of the reproduced sound is deteriorated.

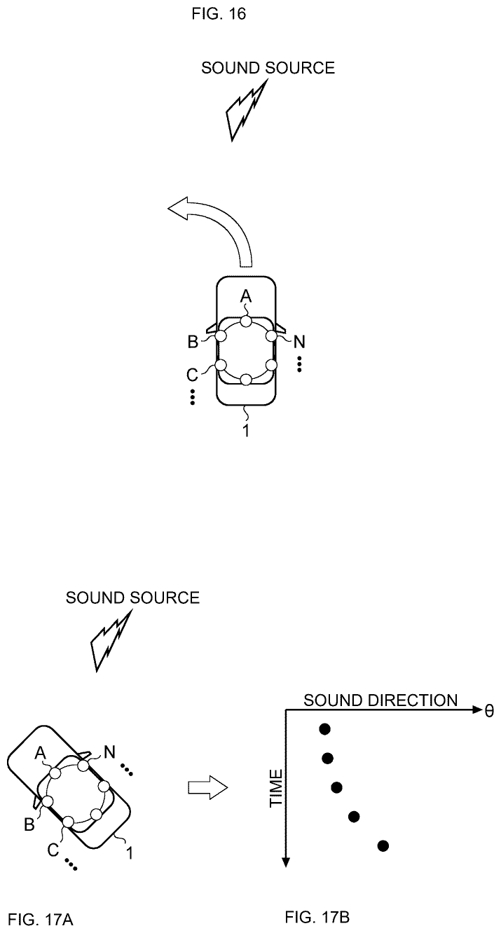

Therefore, in the present embodiment, in a case where the exterior microphone 112 includes a plurality of microphones, the microphone arrangement is devised in such a manner that, for example, the relative position between each of the microphones constituting the exterior microphone 112 and a sound source is substantially constant when the vehicle 1 is turning. FIGS. 16 to 18 are diagrams for describing a microphone arrangement example of the exterior microphone according to the present embodiment.

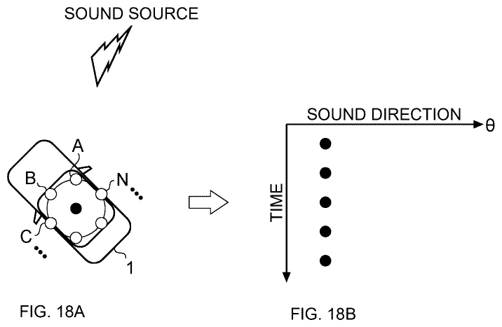

As illustrated in FIG. 16, in a case where the vehicle 1 turns left in a situation where a sound source is present ahead, in a configuration in which each of the microphones A to N (N is an integer greater than or equal to 2) included in the exterior microphone 112 is fixed to the vehicle 1 as illustrated in (A) of FIG. 17, a sound direction θ with respect to the exterior microphone 112 changes with the lapse of time (left turn of the vehicle 1) as illustrated in (B). Therefore, as illustrated in (A) of FIG. 18, a floating mechanism, which always faces a certain direction by magnetism or the like, such as a compass, is provided to the vehicle 1, and the exterior microphone 112 is fixed to the floating mechanism, whereby the sound direction θ with respect to the exterior microphone 112 can be made substantially constant even when the vehicle 1 turns, as illustrated in (B).

Note that the configuration for maintaining the sound direction θ with respect to the exterior microphone 112 is not limited to the floating mechanism as described above, and various modifications may be made, for example, a mechanism that reversely rotates a turntable to which the exterior microphone 112 is fixed in such a manner as to cancel out rotation of the exterior microphone 112 due to turning of the vehicle 1 on the basis of an angular velocity or an angular acceleration generated in the vehicle 1 detected by a gyro sensor or the like.

Meanwhile, in a case where a single microphone constitutes the exterior microphone 112, a mechanism for keeping the direction of the exterior microphone 112 constant, such as a floating mechanism, is not necessary. However, for example, it is preferable to provide the exterior microphone 112 at a position where the position change is small during turning of the vehicle 1 with consideration to a turning radius difference or the like, such as on an axle.

### 1.8 Acoustic Event Specifying Method

The reproduction sound source notification method determining unit 101 (see FIG. 3) detects or identifies a sound source from environmental sound data input thereto and specifies what the acoustic event is. The acoustic event may include information (also referred to as event feature data) related to a feature of an event of the specified sound source. As a method of specifying the acoustic event, for example, it is possible to use a method such as pattern matching for specifying an acoustic event by registering a reference of target sound in advance and comparing an audio signal (environmental sound data) with the reference or a method of outputting the acoustic event using the audio signal (environmental sound data) as input of a machine learning algorithm such as a deep neural network (DNN). For example, in a case where a machine learning algorithm is used, it is possible to specify an acoustic event such as an ambulance, a fire engine, or a railroad crossing from an audio signal (environmental sound data) by generating a learning model that enables classification and recognition of an acoustic event desired to be detected with respect to various types of input data.

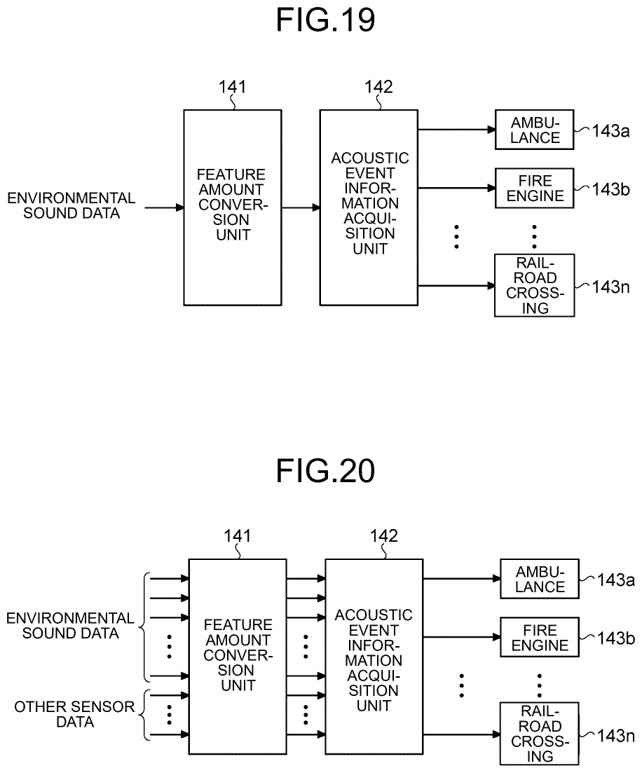

FIG. 19 is a block diagram for describing an acoustic event specifying method according to the present embodiment. Note that, in the present description, a case where an acoustic event is specified using a machine learning algorithm will be described as an example. As illustrated in FIG. 19, the reproduction sound source notification method determining unit 101 includes a feature amount conversion unit 141 and an acoustic event information acquisition unit 142 that outputs acoustic event information using a learning model learned by a machine learning algorithm such as the DNN as a configuration for specifying an acoustic event.

The feature amount conversion unit 141 extracts a feature amount from the environmental sound data by executing predetermined processing such as executing fast Fourier transform on the input environmental sound data to separate the environmental sound data into frequency components. The extracted feature amount is input to the acoustic event information acquisition unit 142. At this point, the environmental sound data itself may also be input to the acoustic event information acquisition unit 142.

The acoustic event information acquisition unit 142 includes, for example, a learned model learned in advance using machine learning such as the DNN in such a manner as to output an acoustic event such as an ambulance 143a, a fire engine 143b, a railroad crossing 143n, and the like with respect to a feature amount (and environmental sound data). When a feature amount (and environmental sound data) is input from the feature amount conversion unit 141, the acoustic event information acquisition unit 142 outputs the likelihood of each of classes registered in advance in a value from 0 to 1 and specifies a class whose value exceeds a preset threshold value or a class having the highest likelihood as an acoustic event of the audio signal (environmental sound data).

Note that, in FIG. 19, a case of a so-called single modal form in which the number of pieces of input of the acoustic event information acquisition unit 142 (which is also input of the feature amount conversion unit 141) is one has been described as an example; however, it is not limited thereto. For example, as illustrated in FIG. 20, it is possible to adopt a so-called multi-channel or multimodal form in which a plurality of pieces of input of the acoustic event information acquisition unit 142 (which is also the input of the feature amount conversion unit 141) is provided and sensor data (feature amount) from the same type and/or different types of sensors is input in each of the plurality of pieces of input.

As the sensor data to be input to the feature amount conversion unit 141 in the case of the multimodal form, in addition to the audio signal (environmental sound data) from the exterior microphone 112, various types of data such as an audio signal (onboard sound data) from the in-vehicle microphone 114, image data from the in-vehicle camera 113, sensor data from other in-vehicle sensors 26, image data from the camera 51, sensor data from the radar 52, the LiDAR 53, and the ultrasonic sensor 54, steering information from the vehicle sensor 27, operation information from the vehicle control unit 32, or various types of data such as traffic condition information acquired via the communication unit 111 (communication unit 22) may be applied. With multi-channelization and/or multi-modalization of input to incorporate a plurality of pieces of and/or a plurality of types of sensor data, it is made possible to achieve various effects such as increasing estimation accuracy and outputting the sound direction or distance information in addition to the likelihood of each class. As a result, in addition to specifying the acoustic event, it is also possible to detect the sound direction, the distance to the sound source, the position of the sound source, or others.

In this manner, by causing the acoustic event information acquisition unit 142 to learn candidate acoustic events in advance for each class, it is made possible to obtain output of a necessary event. In addition, multi-channelization of input signals makes it possible to enhance robustness against wind noise and to simultaneously estimate the sound direction and the distance in addition to the likelihood of a class. Furthermore, by utilizing sensor data from other sensors in addition to the audio signal from the exterior microphone 112, it is made possible to acquire detection information that is difficult if only with the exterior microphone 112. For example, it is possible to track the direction of a car whose sound direction changes after the horn is sounded.

Note that another DNN different from that of the acoustic event information acquisition unit 142 of the present embodiment may be used for detection of the sound direction, the distance to the sound source, the position of the sound source, or the like. At this point, partial processing of the detection processing of the sound direction and the distance may be performed by the DNN. However, it is not limited thereto, and a detection algorithm that is separately prepared may be used for detection of the sound direction and detection of the distance to the sound source. Furthermore, for specifying the acoustic event and detecting the sound direction, the distance to the sound source, the position of the sound source, or the like, beamforming, sound pressure information, or the like may be utilized.

### 1.9 Examples of Display Application

Next, a display application for displaying information regarding the sound direction or the distance specified as described above to the user will be described with some examples. Note that the display application described as an example below may be installed, for example, on an instrument panel (for example, a center cluster) of the vehicle 1 or may be displayed on the display 132 provided on the instrument panel.

### 1.9.1 First Display Example

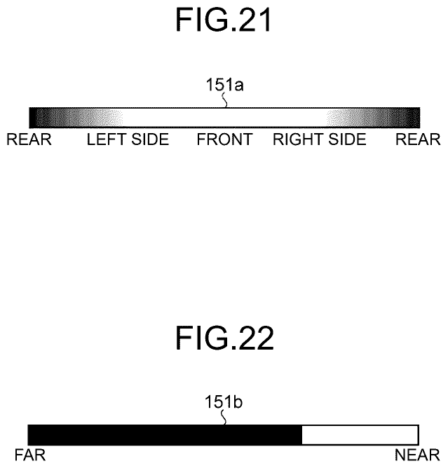

FIG. 21 is a diagram illustrating a display application for the sound direction according to a first display example. FIG. 22 is a diagram illustrating a display application for the distance according to the first display example.

As illustrated in FIG. 21, the direction (corresponding to the sound direction) of the sound source that has caused the acoustic event detected by the reproduction sound source notification method determining unit 101 (hereinafter, also simply referred to as the sound source) with respect to the vehicle 1 may be presented to the user using an indicator 151a in which the center represents the front of the vehicle 1 and both ends represent the rear of the vehicle 1. The example illustrated in FIG. 21 illustrates a case where the direction in which the sound source is present is displayed in an emphasized color such as red in the indicator 151a.

Furthermore, as illustrated in FIG. 22, the distance from the vehicle 1 to the sound source detected by the reproduction sound source notification method determining unit 101 may be presented using an indicator 151b in which one end represents the far side from the vehicle 1 and the other end represents the near side from the vehicle 1.

By displaying to the user using such indicators 151a and 151b, it is possible to promptly notify the driver of the presence of the acoustic event when the acoustic event is detected, and it is possible to present to the user whether the sound direction is ahead of or behind the vehicle 1 in a visually easy-to-understand form. Furthermore, even in a state where the sound source cannot be detected by the camera 51, the radar 52, the LiDAR 53, the ultrasonic sensor 54, or the like, the direction can be presented to the user. Furthermore, even for the same acoustic event, by acquiring detailed information such as a direction or a distance, the information can be used as a basis for determination when the importance of whether or not the information is to be notified to the user is determined.

Note that, in addition to the indicators 151a and 151b, in a case where it is determined from the distance information that the sound source is approaching, guidance for urging some action to the driver of the vehicle 1 may be presented using characters, gauges, sound, or others. Furthermore, an audio signal of the acoustic event (hereinafter, an audio signal of an acoustic event is also simply referred to as an acoustic event) may be reproduced in the vehicle in such a manner that the user hears the sound as that from the detected sound direction.

### 1.9.2 Second Display Example

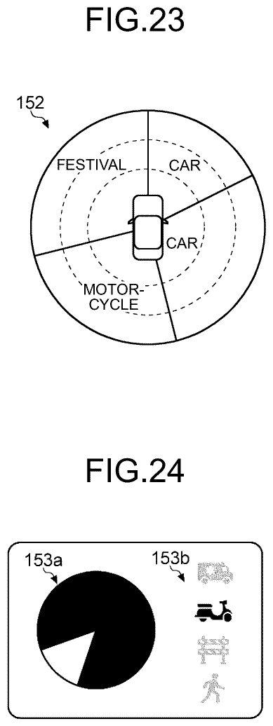

FIG. 23 is a diagram illustrating a display application for the sound direction according to a second display example. As illustrated in FIG. 23, the direction of the acoustic event detected by the reproduction sound source notification method determining unit 101 with respect to the vehicle 1 (corresponding to the sound direction) may be presented to the user using a disc chart 152 in which the vehicle 1 is disposed at the center. Furthermore, in the disc chart 152, what type of sound source is present in each direction may be presented to the user using text, icons, color coding, or others. By visually presenting the direction based on the vehicle 1 for each acoustic event to the user using such a disc chart 152, it is possible to enable the driver to intuitively grasp the situation outside the vehicle. Furthermore, for example, as illustrated in FIG. 23, it is possible to visually express the distance to each acoustic event by dividing the disc chart into several concentrical regions and displaying metadata such as text, icons, and color coding indicating the type of the sound source in the divided regions or displaying the metadata of the sound source in such a manner that the distance from the icon of the vehicle 1 displayed in the center changes depending on the detected distance between the vehicle 1 and the sound source.

In addition, even if there is a period in which the sound source does not emit sound, an icon of an acoustic event may be displayed in cooperation with the operation information, the steering information, or the like in such a manner that the relative positional relationship with the sound source is maintained for a certain period after the acoustic event is once detected.

### 1.9.3 Third Display Example

FIG. 24 is a diagram illustrating a display application for the sound direction according to a third display example. As illustrated in FIG. 24, the direction of the acoustic event detected by the reproduction sound source notification method determining unit 101 with respect to the vehicle 1 (corresponding to the sound direction) may be presented to the user using a disc chart 153a in which the vehicle 1 is disposed at the center, similarly to the second display example. At this point, what is the sound source present in that direction may be presented to the user using, for example, icons 153b, text, or others.

### 1.9.4 Fourth Display Example

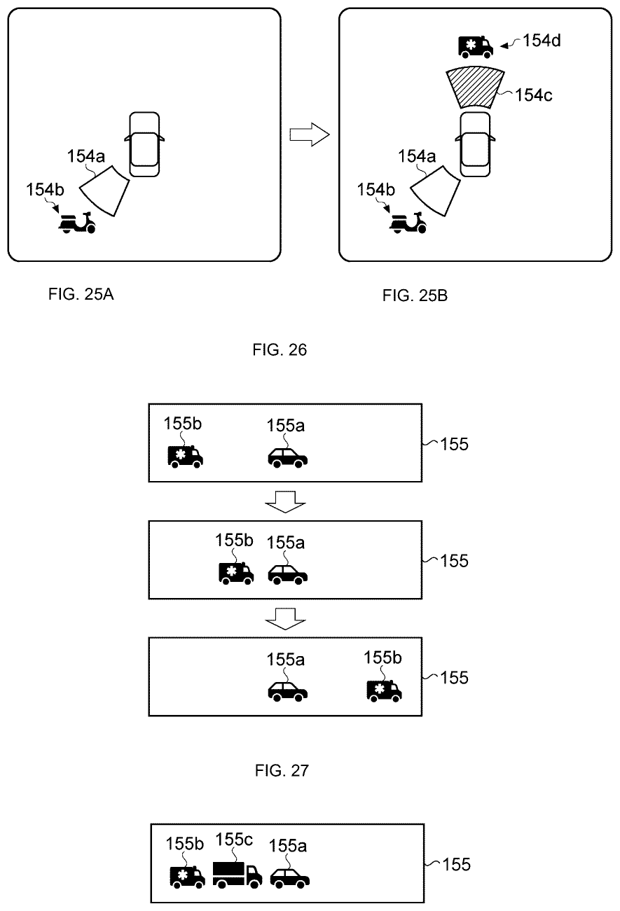

FIG. 25 is a diagram illustrating a display application for the sound direction according to a fourth display example. As illustrated in (A) of FIG. 25, the direction (corresponding to the sound direction) of the acoustic event detected by the reproduction sound source notification method determining unit 101 with respect to the vehicle 1 may be presented to the user using an icon (for example, a portion of a donut chart) 154a indicating in which direction the sound source is present with the vehicle 1 as a fixed center and an icon 154b indicating the sound source present in that direction. In addition, as illustrated in (B), for example, in a case where there is a sound source having a high notification priority such as an emergency vehicle in a specific direction from the vehicle 1 (front in (B) of FIG. 25), an icon 154c indicating the direction or an icon 154d indicating the sound source may be blinked or displayed in an emphasized color. At this point, the presence or approach of the emergency vehicle or the like may be notified to the user by using voice or the like.

### 1.9.5 Fifth Display Example

FIG. 26 is a diagram illustrating a display application for the distance according to a fifth display example. As illustrated in FIG. 26, the distance between the sound source and the vehicle 1 may be presented to the user using an indicator 155 in which an icon 155a of the vehicle 1 is disposed at the center with the horizontal direction indicating the distance. With presentation to the user using the indicator 155 in which the horizontal direction indicates the distance, it is possible to present the distance to the target object to the user in a visually easily understandable manner.

In addition, as illustrated in FIG. 27, in a case where one or more other objects such as automobiles are present between an object having a high notification priority such as an emergency vehicle and the vehicle 1, the icon 155a of the vehicle 1, the icon 155b of the emergency vehicle, and an icon 155c of the one or more other objects may be displayed on the indicator 155, for example, after acquiring information regarding the one or more other objects using information obtained by other sensors such as the camera 51, the radar 52, the LiDAR 53, or the ultrasonic sensor 54 or information obtained by vehicle-to-vehicle communication via the communication unit 111 (22).

As described above, notification of an acoustic event (also referred to as notification of metadata of the sound source) may include identifiably assigning at least one of the color, the ratio, or the display area for each piece of event feature data of the acoustic event.

In addition, as the notification method of an acoustic event, a method of displaying the icon of the vehicle 1 and the icon of the sound source in an overlapping manner on a map displayed on the display 132 or the like may be adopted.

### 1.10 Application Example of Display Application

For the acoustic event presented to the user by using such a display application as described above, the user may select whether to reproduce the acoustic event at a normal volume or an emphasized volume, to reproduce the acoustic event at a suppressed volume, or to hide the acoustic event in the display application in and after the next notification. This selection may be enabled, for example, by designing the display application as a graphical user interface (GUI). Hereinafter, a case where the second display example described above with reference to FIG. 23 is used as a basis will be described; however, it is not limited thereto, and it goes without saying that other display examples can be used as a basis.

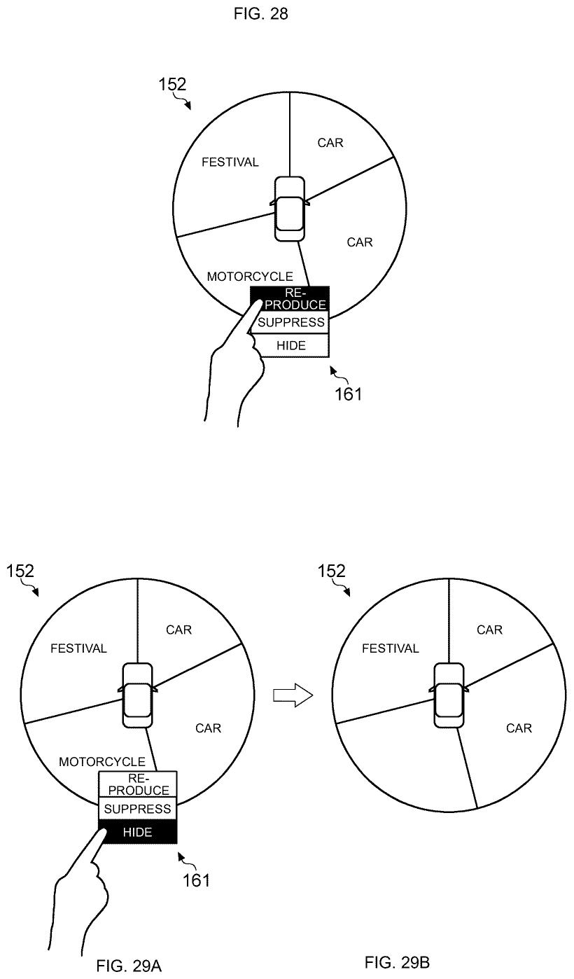

FIGS. 28 and 29 are diagrams for explaining a disc chart designed as a GUI according to the present embodiment. Note that it is based on the premise that, in a state before changing the settings, an acoustic event having high importance for the user, such as an emergency vehicle being approaching, is set to be reproduced at a normal volume or an emphasized volume and that other acoustic events are displayed in the GUI but are not reproduced.

First, as illustrated in FIG. 28, when a display area of an acoustic event that the user desires to set is selected with a finger or the like on the disc chart 152 designed as a GUI, a selection menu 161 for the acoustic event of the display area touched by the finger is displayed with the touched position being the origin. For example, when the user selects “Reproduce” on the displayed selection menu 161, the setting is updated such that the selected acoustic event is reproduced at a normal volume or an emphasized volume. In addition, for example, when the user selects “Suppress”, masking noise that cancels sound leaking into the vehicle is reproduced such that the selected acoustic event is suppressed. Meanwhile, as illustrated in (A) of FIG. 29, for example, when the user selects “Hide” on the displayed selection menu 161, as illustrated in (B), the setting is updated such that display in the disc chart 152 related to the selected acoustic event is not performed and that the acoustic event is not reproduced.

As described above, by designing the display application as the GUI, it is possible to monitor the sound outside the vehicle by the type, the direction, and the distance and to construct an environment in which the user can visually perform selection of sound desired to be heard, setting of an event desired to be automatically notified at the time of detection in the future, operation on sound desired to be suppressed by masking, and others. For example, the user can individually set how to handle the next and subsequent events by touching the type of the sound source displayed in the display application.

Note that the setting for each acoustic event may be implemented by a voice operation or the like instead of a touch operation. For example, for an acoustic event which the user does not want to be automatically notified in the future, it may be set not to notify the user in the next time and subsequent times with the user uttering “Do not notify next time” or the like.

In addition, the settings such as “reproduce”, “suppress”, and “hide” may be variously modified such as enabling setting for each distance. This makes it possible to obtain an effect of enabling settings to conform more to the user's preferences.

### 1.11 Detection Notification of Emergency Vehicle

Sensors such as the camera 51, the radar 52, the LiDAR 53, and the ultrasonic sensor 54 (hereinafter, also referred to as the camera 51 or the others) can detect an emergency vehicle having a specific shape such as a police car, an ambulance, and a fire engine; however, it is difficult to determine whether or not the emergency vehicle is traveling in an emergency. Meanwhile, in a configuration in which an emergency vehicle can be detected on the basis of sound as in the present embodiment, whether or not the emergency vehicle is traveling in an emergency can be easily determined. Furthermore, in the present embodiment in which an emergency vehicle can be detected on the basis of sound, even at an intersection or on a road with a lot of traffic volume with poor visibility, it is possible to accurately detect the presence of the emergency vehicle before the emergency vehicle approaches.

In addition, by using a multi-microphone (see, for example, FIG. 8) including a plurality of microphones as the exterior microphone 112, the sound direction can be detected from phase difference information between the microphones. Furthermore, by specifying the Doppler effect from the waveform and the frequency of audio signals detected by the exterior microphone 112, it is also possible to detect information about whether the emergency vehicle is approaching or separated.

On the other hand, it is difficult to determine only by the sound which street the emergency vehicle is traveling on, whether the emergency vehicle is traveling on the same lane or on an on-coming lane even in a case where the emergency vehicle is close, and so on. Therefore, for specifying these pieces of information, sensor data acquired by the camera 51 or the others, position information of surrounding vehicles received via the communication unit 22, or the like may be used.

For example, it may be configured to enter a state in which the presence of an emergency vehicle is detected on the basis of sound to call for the user's attention, to specify the position, the traveling lane, and the like of the emergency vehicle are specified by the camera 51 or the others from the sound direction specified on the basis of the sound, and to determine the priority level for notification to the driver.

In addition, in a case where an emergency vehicle is detected on the basis of sensor data from a single sensor (the exterior microphone 112, the camera 51, or the others), a detection notification or an alarm keeps ringing in the vehicle until the emergency vehicle is no longer detected after the emergency vehicle is detected. However, in a case where there is no influence on the driving operation such as avoidance of entry to an intersection or giving way due to approach from behind, such as a case where the emergency vehicle present in a distant place is detected, making the detection notification or the alarm ringing continuously from detection of the emergency vehicle until the emergency vehicle is no longer detected can not only reduces comfort in the vehicle but also possibly cause the driver to overlook a target object to which the driver should pay more attention, such as a pedestrian in the vicinity of the vehicle. That is, for example, in a case where the driver performs some avoidance driving operation after being notified that the emergency vehicle has been detected, it is conceived less necessary to sound the detection notification or the alarm thereafter.

Therefore, in the present embodiment, in a case where the driver performs some avoidance driving operation after the detection of the emergency vehicle is notified, the detection notification and the alarm are stopped. This makes it possible to reduce the possibility that the driver overlooks a target object to which the driver should pay more attention while suppressing a decrease in comfort such as hindering viewing of audio content in the vehicle.

Note that, since it is sufficient for the audio notification to be recognized by the driver, for example, in a surround audio environment in which the speaker 131 is a multi-speaker, it is possible to secure the quality of entertainment at seats other than the driver's seat by performing a notification of the approaching emergency vehicle by lowering the priority of content only in the speaker for the driver without lowering the volume of speakers for the back seat.

### 1.12 Notification Priorities

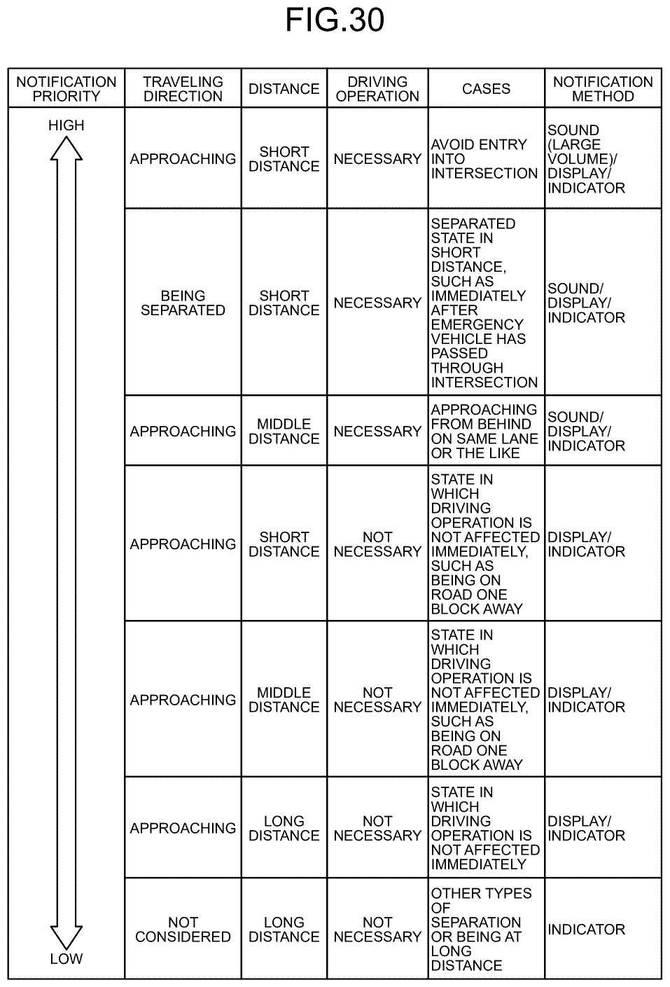

As described above, in a case where detailed information regarding an acoustic event is detected, the notification method to the driver can be changed depending on the importance of the information. FIG. 30 is a table summarizing determination criteria examples of notification priorities with regards to an emergency vehicle according to the present embodiment. As illustrated in FIG. 30, the notification priority may be set depending on, for example, items such as the traveling direction of a target object (an emergency vehicle in this example) serving as a sound source, the distance to the target object, or whether or not the driver of the vehicle 1 needs to perform a driving operation such as avoidance.

In addition, a notification method in each case may be set in the table. The reproduction sound source notification method determining unit 101 may issue an instruction to the notification control unit 102 in such a manner that the user is notified by the notification method set in each case.

In the example illustrated in FIG. 30, in a case where there is a high possibility of affecting the travel of another vehicle or the emergency vehicle, a high notification priority is set such that the driver is sufficiently notified, and a plurality of notification methods is set such that the driver is notified by a plurality of means. In addition, in a case where it is not necessary to take a driving action immediately, a moderate notification priority is set, and a plurality of notification methods is set such that the driver is notified, by a plurality of means, of the possibility that it is required to be sufficiently careful in the near future. Furthermore, in a case where it is possible to confirm the presence of the emergency vehicle but it is unlikely that the driving of the host vehicle be affected, a low notification priority is set, and about one or two notification methods are set such that the driver is notified by some means.

The reproduction sound source notification method determining unit 101 may determine the notification priority of the detected acoustic event on the basis of such a table and issue an instruction corresponding to the notification priority to the notification control unit 102 in accordance with a notification method that is set.

1.13 Examples of Notification Operation with Regards to Emergency Vehicle

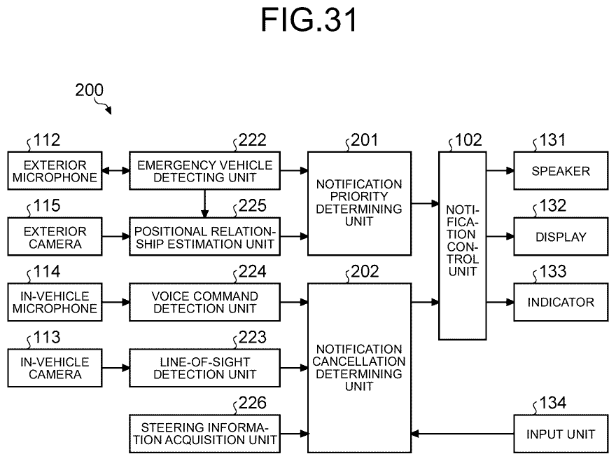

Next, operations (hereinafter, also referred to as the notification operation) from determination of the notification priority with regards to the emergency vehicle to cancellation of the notification will be described. FIG. 31 is a block diagram for explaining a notification operation according to the present embodiment. Note that, in the following description, the same components as those illustrated in FIG. 3 are denoted by the same reference numerals.

As illustrated in FIG. 31, in the acoustic control device 100 according to the present embodiment, a notification control device 200 that executes the operation from determination of the notification priority with regards to the emergency vehicle to cancellation of the notification includes, for example, an exterior microphone 112, an exterior camera 115, an in-vehicle microphone 114, an in-vehicle camera 113, an emergency vehicle detecting unit 222, a positional relationship estimation unit 225, a voice command detection unit 224, a line-of-sight detection unit 223, a steering information acquisition unit 226, a notification priority determining unit 201, a notification cancellation determining unit 202, a notification control unit 102, a speaker 131, a display 132, an indicator 133, and an input unit 134.

Among these configurations, the exterior microphone 112, the in-vehicle microphone 114, the in-vehicle camera 113, the notification control unit 102, the speaker 131, the display 132, the indicator 133, and the input unit 134 may be the same as those in FIG. 3, and the exterior camera 115 may have a configuration corresponding to that of the camera 51 in FIG. 1. Furthermore, at least one of the emergency vehicle detecting unit 222, the positional relationship estimation unit 225, the voice command detection unit 224, the line-of-sight detection unit 223, the steering information acquisition unit 226, the notification priority determining unit 201, or the notification cancellation determining unit 202 may be implemented in the reproduction sound source notification method determining unit 101 in the acoustic control device 100 illustrated in FIG. 3.

Furthermore, for example, at least one of the emergency vehicle detecting unit 222, the positional relationship estimation unit 225, the voice command detection unit 224, the line-of-sight detection unit 223, the steering information acquisition unit 226, the notification priority determining unit 201, the notification cancellation determining unit 202, and the notification control unit 102 may be disposed in another information processing device that is mounted on the vehicle 1 and connected with the vehicle control system 11 via the CAN, a server (including a cloud server) disposed on a network outside the vehicle, such as the Internet, to which the acoustic control device 100 and/or the vehicle control system 11 can be connected via the communication unit 111, the communication unit 22, and/or others.

### (Emergency Vehicle Detecting Unit 222)

The emergency vehicle detecting unit 222 detects an emergency vehicle (police car, ambulance, fire engine, and so on) on the basis of, for example, an audio signal input from the exterior microphone 112 or environmental sound data (hereinafter, a case where an audio signal is used will be described as an example) input from the environmental sound acquisition unit 122 (see FIG. 3). For detection of an emergency vehicle, the above-described detection method of an acoustic event may be used.

### (Positional Relationship Estimation Unit 225)

The positional relationship estimation unit 225 estimates the positional relationship between the emergency vehicle detected by the emergency vehicle detecting unit 222 and the vehicle 1, for example, by analyzing sensor data input from the external recognition sensor 25 such as the exterior camera 115, the other radar 52, LiDAR 53, ultrasonic sensor 54, or others. At this point, the positional relationship estimation unit 225 may estimate the positional relationship between the emergency vehicle and the vehicle 1 further on the basis of the traffic condition information received via the communication unit 111.

### (Voice Command Detection Unit 224)

The voice command detection unit 224 detects a voice command input from a user such as a driver on the basis of, for example, an audio signal input from the in-vehicle microphone 114 or onboard sound data (hereinafter, a case where an audio signal is used will be described as an example) input from sound acquisition unit 124 (see FIG. 3).

### (Line-of-Sight Detection Unit 223)

For example, the line-of-sight detection unit 223 detects posture information (line-of-sight direction or the like) of the driver by analyzing image data acquired by the in-vehicle camera 113.

### (Steering Information Acquisition Unit 226)

The steering information acquisition unit 226 detects whether or not the driver has performed an avoidance driving operation for avoiding the emergency vehicle such as an avoidance operation by analyzing, for example, steering information from the vehicle sensor 27 or operation information from the vehicle control unit 32.

### (Notification Priority Determining Unit 201)

For example, with detection of the emergency vehicle by the emergency vehicle detecting unit 222 as a trigger, the notification priority determining unit 201 discriminates and determines the notification priority and the notification method with regards to the emergency vehicle on the basis of the positional relationship between the emergency vehicle and the vehicle 1 estimated by the positional relationship estimation unit 225, for example, in accordance with the table illustrated in FIG. 30. Note that, as for notification to the user, the notification priority determining unit 201 may directly instruct the notification control unit 102 to notify the user, or the notification priority determining unit 201 may instruct the reproduction sound source notification method determining unit 101 via the reproduction sound source notification method determining unit 101.

### (Notification Cancellation Determining Unit 202)

The notification cancellation determining unit 202 determines cancellation of the notification to the user related to the emergency vehicle on the basis of, for example, at least one of a voice command input from the user detected by the voice command detection unit 224, the posture information of the driver detected by the line-of-sight detection unit 223, the information about whether or not the driver has performed the avoidance driving operation that is detected by the steering information acquisition unit 226, or a notification cancellation instruction input from the input unit 134. Then, the notification cancellation determining unit 202 instructs the notification control unit 102 to cancel the notification to the user of the emergency vehicle using at least one of the speaker 131, the display 132, or the indicator 133. The notification cancellation determining unit 202 may directly instruct the notification control unit 102 to cancel the notification, or the notification cancellation determining unit 202 may instruct cancellation to the reproduction sound source notification method determining unit 101 via the reproduction sound source notification method determining unit 101.

### 1.14 Exemplary Flow of Notification Operation Regarding Emergency Vehicle

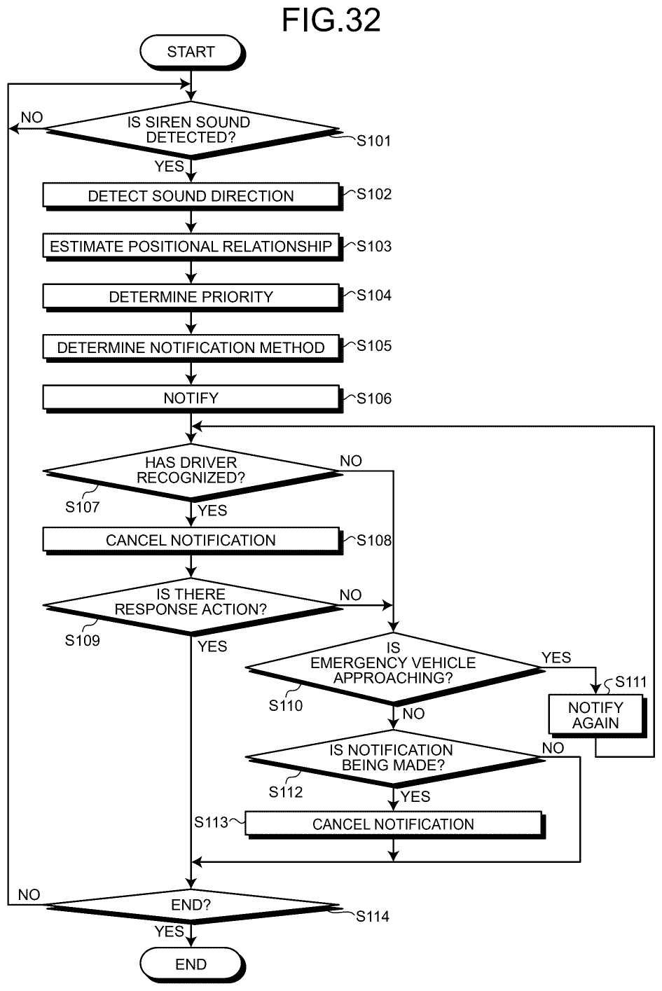

Next, an example of the notification operation related to an emergency vehicle will be described. FIG. 32 is a flowchart illustrating an example of the notification operation related to an emergency vehicle according to the present embodiment.

As illustrated in FIG. 32, in the present operation example, first, the emergency vehicle detecting unit 222 executes recognition processing on an audio signal (or environmental sound data) input from the exterior microphone 112 (step S101) and waits until siren sound during emergency driving is detected by the recognition processing (NO in step S101).

If the siren sound is detected (YES in step S101), the emergency vehicle detecting unit 222 detects a direction (sound direction) of the emergency vehicle that has emitted the siren sound with respect to the vehicle 1 (step S102). Note that, in a case where the sound direction of the siren sound (acoustic event) is detected in the recognition processing of step S101, this step S102 may be omitted. In step S102 (or step S101), the distance from the vehicle 1 to the emergency vehicle may also be detected in addition to the sound direction. Furthermore, as described above, sensor data from the exterior camera 115 (corresponding to the camera 51) or the others may be used for detection of the sound direction (and the distance) in addition to the audio signal (or environmental sound data).

Next, the positional relationship estimation unit 225 estimates the positional relationship (for example, a more accurate sound direction and distance) between the emergency vehicle and the vehicle 1 by analyzing sensor data obtained by sensing of the sound direction detected in step S102 (or step S101) using the external recognition sensor 25 such as the exterior camera 115 and the other radar 52, LiDAR 53, or ultrasonic sensor 54 (step S103). At this point, in addition to the sound direction detected in step S102 (or step S101), the positional relationship estimation unit 225 may estimate the positional relationship between the emergency vehicle and the vehicle 1 further using the distance to the emergency vehicle detected in the same step S102 (or step S101), the traffic condition information received via the communication unit 111, and the like.

Next, the notification priority determining unit 201 determines the notification priority with regards to the emergency vehicle on the basis of the positional relationship between the emergency vehicle and the vehicle 1 estimated by the positional relationship estimation unit 225, for example, in accordance with the table illustrated in FIG. 30 as an example (step S104).

The notification priority determining unit 201 also determines the notification method to the user on the basis of the positional relationship between the emergency vehicle and the vehicle 1 estimated by the positional relationship estimation unit 225, for example, in accordance with to the table illustrated in FIG. 30 as an example (step S105).

When the notification priority and the notification method are determined in this manner, the notification control unit 103 notifies the user of the information about the emergency vehicle using at least one of the speaker 131, the display 132, or the indicator 133 in accordance with the notification priority and the notification method that have been determined (step S106).

Next, the line-of-sight detection unit 223 detects posture information of the driver by analyzing the image data acquired by the in-vehicle camera 113 and determines whether or not the driver has recognized the emergency vehicle by the notification in step S106 (step S107). If it is determined that the driver does not recognize the emergency vehicle (NO in step S107), this operation proceeds to step S110.

On the other hand, if it is determined that the driver has recognized the emergency vehicle (YES in step S107), the notification cancellation determining unit 202 determines to temporarily cancel the notification of the emergency vehicle to the driver and cancels the notification by the notification control unit 103 (step S108). Subsequently, the notification cancellation determining unit 202 determines whether or not the driver has performed a response action such as an avoidance driving operation for the emergency vehicle on the basis of at least one of, for example, a voice command from the user detected by the voice command detection unit 224, the posture information of the driver detected by the line-of-sight detection unit 223, the information about whether or not the driver has performed the avoidance driving operation that is detected by the operation information acquisition unit 226, or a notification cancellation instruction input from the input unit 134 (step S109). If the response action has been performed (YES in step S109), the present operation proceeds to step S114. On the other hand, if no response action has been performed by the driver (NO in step S109), the operation proceeds to step S110.

In step S110, the emergency vehicle detecting unit 222 and/or the positional relationship estimation unit 225 determines whether the emergency vehicle detected in step S101 is approaching the vehicle 1. If the emergency vehicle is approaching (YES in step S110), the notification priority determining unit 201 determines the notification priority and determines the notification method similarly to steps S104 and S105, and the notification control unit 103 notifies the user of the information about the emergency vehicle again in accordance with the notification priority and the notification method that have been determined (step S111) Then, the operation returns to step S107.

Contrarily, if the emergency vehicle is not approaching (NO in step S110), the notification cancellation determining unit 202 determines whether or not a notification is currently being made to the driver (step S112). If the notification is being made (YES in step S112), the notification is canceled (step S113), and the process proceeds to step S114. Contrarily, if the notification is not being made (NO in step S112), the process directly proceeds to step S114.

In step S114, it is determined whether or not to end the present operation, and if the operation is to be ended, the present operation is ended (YES in step S114). Contrarily, if it is not ended (NO in step S114), the present operation returns to step S101, and the subsequent operations are continued.

### 1.15 Example of Notification Method in Multi-Speaker Environment

Next, an exemplary notification method to the user in a case where the speaker 131 is a multi-speaker including a plurality of speakers will be described.

In a case where the speaker 131 includes a driver-dedicated speaker in addition to a surround speaker including a plurality of speakers or a speaker for reproducing audio content, namely, in a case where the speaker 131 is a multi-speaker, it is also possible to switch the notification method in the vehicle for each acoustic event that is detected.

In a case where it is desired to notify only the driver of information that affects the driving operation, for example, at a time when an emergency vehicle is approaching, if the control of the entire speaker system in the vehicle is occupied, there is a possibility that viewing of entertainment content in the back seat is hindered. In such a case, by notifying only the driver of the approach of the emergency vehicle, deterioration in the quality of in-vehicle entertainment can be suppressed.

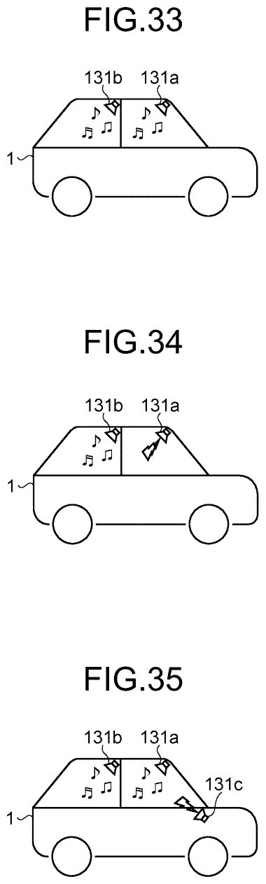

As illustrated in FIG. 33, for example, in a space acoustically designed for each sheet in which one of speakers 131a and 131b is disposed, it is possible to reproduce the notification sound only from the speaker 131a for the driver without stopping reproduction of the audio content from the speaker 131a as illustrated in FIG. 34.

Alternatively, the object is also achieved by notifying the driver by means other than the speakers 131a and 131b that are for the content. As illustrated in FIG. 35, for example, in a case where a dedicated speaker 131c is provided in close proximity to the driver's seat (namely, the driver) separately from the speakers 131a and 131b for the content, the notification may be given from this speaker 131c to the driver. Alternatively, the driver may be notified by a method such as vibration of the steering wheel or the seat.

1.16 Cooperation with Other Sensors

In the method of detecting an acoustic event using an audio signal detected by the microphone and estimating the direction thereof or the distance thereto as described above, there is a possibility that the target object cannot be detected in a period in which no sound is emitted, whereas the object can be detected in a period in which sound is emitted. In a case of a moving body such as an automobile, even in a case where an acoustic event is detected once and the direction is specified, there is a possibility that a relative position always moves due to traveling of the host vehicle or the target object, and thus deviation may occur in the direction display when the sound is temporarily stopped, whereas detection can be continuously performed in a case where the target event continuously emits sound.

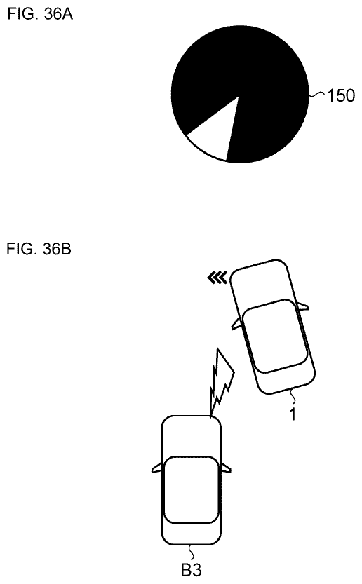

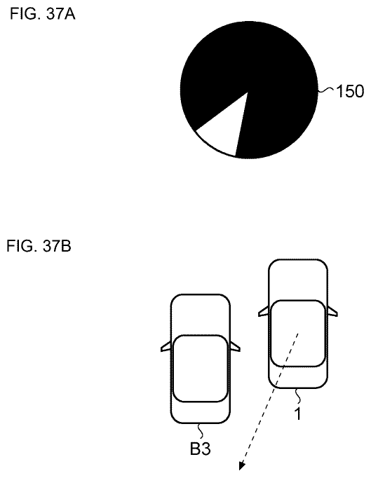

For example, as illustrated in (B) of FIG. 36, in a case where a vehicle B3 on the left rear side sounds a horn when the vehicle 1 attempts to change the lanes, a display application 150 of vehicle 1 is in a state of notifying that the vehicle B3 is present on the left rear side as illustrated in (A). Note that, in FIG. 36, the disc chart 152 or 153a as illustrated in FIG. 23 or 24 as an example is cited as the display application 150; however, it is not limited thereto, and another display application as illustrated in FIGS. 25 to 27 as an example may be used.

Then, as illustrated in (B) of FIG. 37, in a case where the traveling direction of the vehicle 1 is rewound to a direction parallel to the current lane without changing the lanes in a state where the horn is stopped, the vehicle B3 cannot be detected based on an audio signal at that point. Therefore, as illustrated in (A), the display application 150 of the vehicle 1 maintains the state of notifying that the vehicle B3 is present on the left rear side.

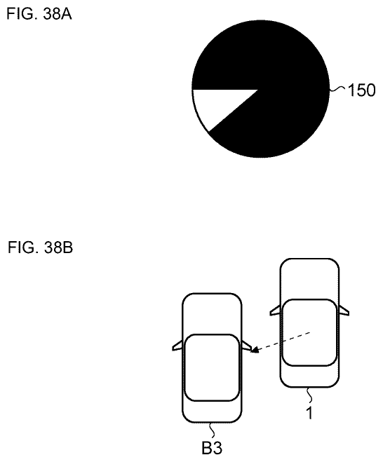

However, actually, the vehicle B3 is located on the left side slightly behind the vehicle 1, and thus the display application 150 of the vehicle 1 needs to notify that the vehicle B3 is present on the left side slightly behind as illustrated in (A) and (B) of FIG. 38.

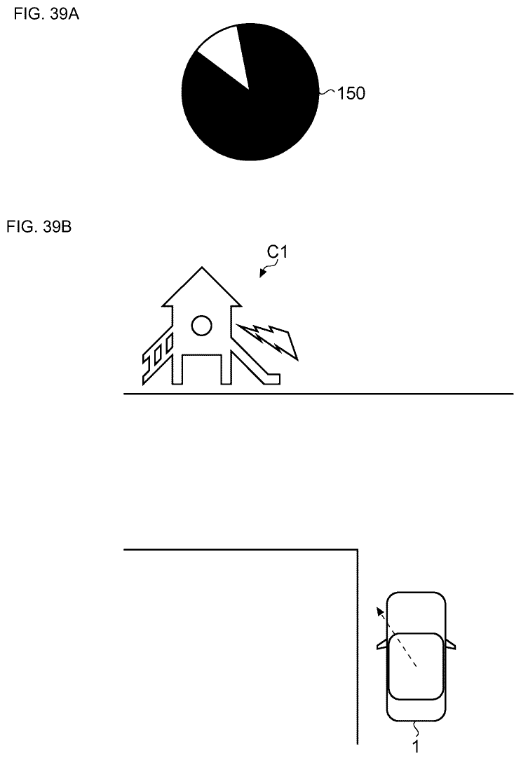

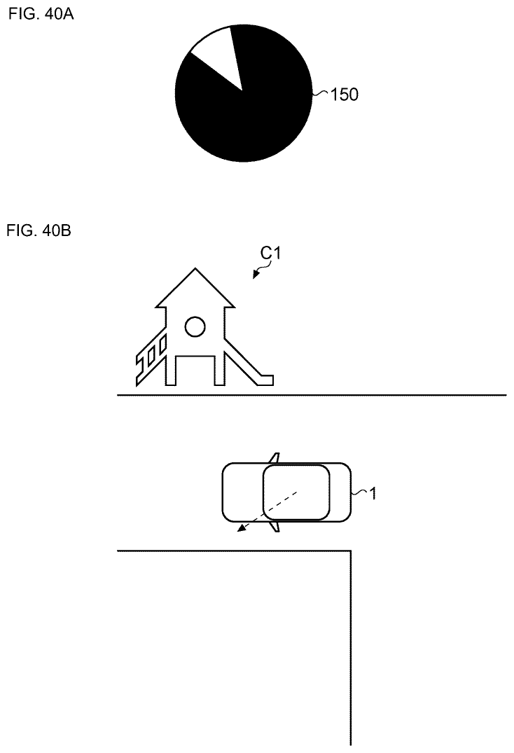

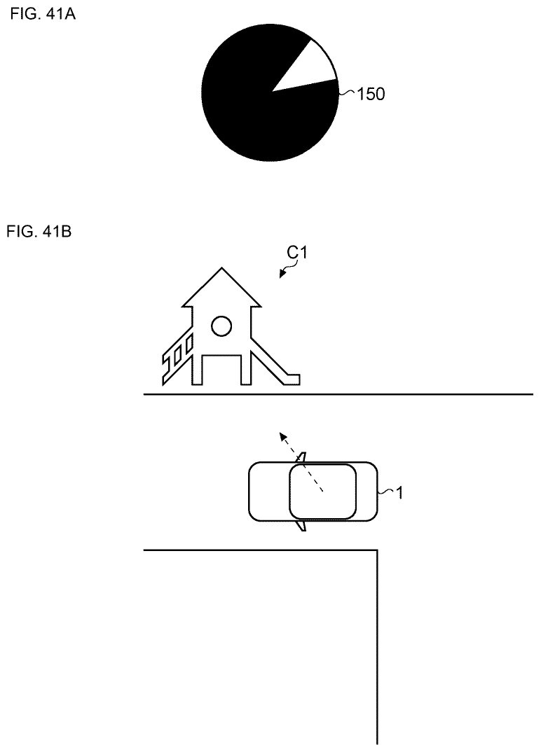

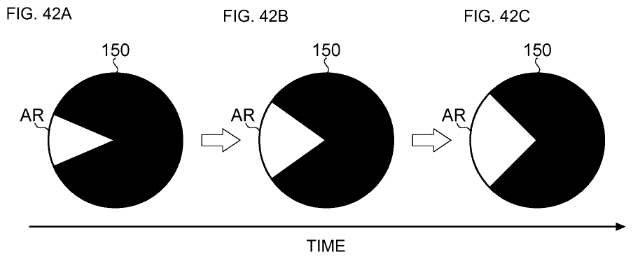

Furthermore, for example, as illustrated in (B) of FIG. 39, in a case where there is a facility C1 such as a park, a kindergarten, or an elementary school on the left front side and children are making sound at the facility C1, the display application 150 of the vehicle 1 is in a state of notifying that the facility C1 is present on the left front side as illustrated in (A).

Then, as illustrated in (B) of FIG. 40, in a case where the vehicle 1 turns left in a state where the children's voice has disappeared, the facility C1 cannot be detected on the basis of the audio signal at this point. Therefore, as illustrated in (A), the display application 150 of the vehicle 1 maintains the state of notifying that the facility C1 is present in the left front.

However, since the facility C1 is actually located in the right front of the vehicle 1, the display application 150 of the vehicle 1 needs to notify that the facility C1 is present in the right front as illustrated in (A) and (B) of FIG. 41.

Therefore, in the present embodiment, as described above, the positional relationship of a target object with respect to the vehicle 1 is estimated on the basis of various types of data such as sensor data from the external recognition sensor 25 such as the camera 51, the radar 52, the LiDAR 53, or the ultrasonic sensor 54, steering information from the vehicle sensor 27, operation information from the vehicle control unit 32, or traffic condition information acquired via the communication unit 111 (communication unit 22), and the display direction in the display application 150 is updated on the basis of the estimated positional relationship. As a result, for example, in the case illustrated as an example in FIG. 38, the display direction of the vehicle B3 can be set to a correct direction in real time, whereby it is possible to avoid dangerous driving due to the display direction of the display application 150 not being updated. In addition, in the case illustrated as an example in FIG. 41, the display direction of the facility C1 can be set to a correct direction in real time, whereby it is possible to notify the driver to carefully drive assuming that a child might abruptly appear near the facility C1.

### 1.17 Log Recording

An acoustic event detected as described above, the driving situation when each acoustic event is detected, and data (including image data) acquired by various sensors may be accumulated as a log in the recording unit 28 in the vehicle control system 11 or a storage area disposed on a network connected via the communication unit 22. The accumulated log may be reproducible later by the user using an information processing terminal such as a smartphone or a personal computer. For example, a summary video of the day may be automatically generated from the log acquired during traveling on a certain day and be provided to the user. This makes it possible to reproduce the experience of that time at timing desired by the user. Note that the sound to be reproduced is not limited to the actually recorded sound but may be variously modified such as a sound sample prepared in advance as a template.

In addition, examples of the information recorded as the log include a conversation time in the vehicle, sound, a video, text, and the like of an excited conversation, a title, sound, and a video of a song when music or radio is reproduced in the vehicle, a time, sound, and a video when a horn is sounded, a time, sound, and a video when the vehicle passes through the vicinity of an event venue such as a festival, a time, sound, and a video when the vehicle travels on a road along the sea, a mountain road, and the like, a time, sound, and a video when a chirp of a bird, a cicada, or the like is heard, and various environmental sounds during traveling.

### 1.18 Change Over Time in Display Direction

In the above-described configuration, for example, in a case where sound is constantly emitted from a target object, or in a case where an object specified from sensor data of the camera 51 or the others and an acoustic event are matched and the target object is successfully tracked, it is possible to present the correct display direction in the display application 150 to the user even if the relative position between the vehicle 1 and the target object changes. Note that matching between the object and the acoustic event may be performed by specifying a relationship between event feature data of the acoustic event and object feature data representing the features of the object.

However, in a case where the sound emitted by the target object is intermittent and it takes time to re-detect the object, or in a case where matching between the object and the acoustic event has failed, it is not possible to specify the relative position between the vehicle 1 and the object during a period in which the target object is not emitting sound. Therefore, during the period in which the target object does not emit sound, the range in which the target object may be present with reference to the vehicle 1 gradually spreads. As a result, there is a possibility that the relative position of the target object actually present deviates from the range of the display direction of the target object presented to the user using the display application 150 when the target object has been detected.

Therefore, in the present embodiment, as illustrated in (A) to (C) of FIG. 42, the display of the display application 150 is updated in such a manner that the angular range of a display direction AR of the target object gradually spreads with the lapse of time during a period in which the target object is lost. This makes it possible to reduce the possibility that an incorrect display direction is presented to the user. Note that, in a case where the target object has been lost for a predetermined period or longer, the notification of the target object using the display application 150 may be canceled.

### 1.19 Exemplary Operation Flow of Change Over Time in Display Direction

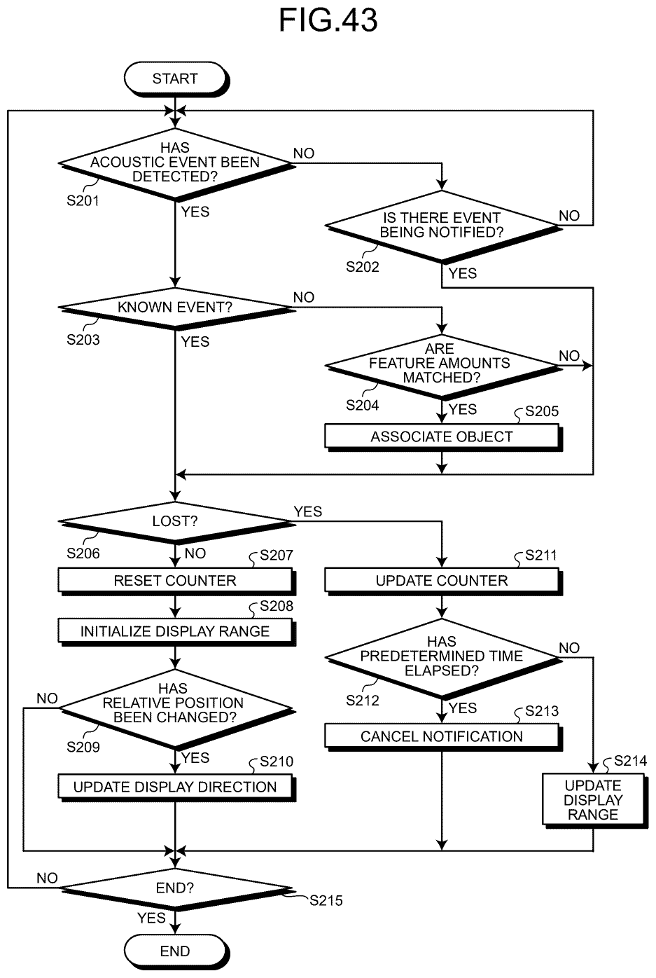

FIG. 43 is a flowchart illustrating an example of an operation flow of changing the display direction over time according to the present embodiment. Note that, in the present description, focus is laid on the operation of the reproduction sound source notification method determining unit 101 in the acoustic control device 100 illustrated in FIG. 3.

As illustrated in FIG. 43, in the present operation, first, the reproduction sound source notification method determining unit 101 executes recognition processing on an audio signal (or environmental sound data) input from the exterior microphone 112 and determines whether or not an acoustic event has been detected by the recognition processing (step S201).

If no acoustic event has been detected by the recognition processing in step S201 (NO in step S201), the reproduction sound source notification method determining unit 101 determines whether or not there is an acoustic event being notified to the user using the display application 150 (step S202). If there is no acoustic event being notified (NO in step S202), the reproduction sound source notification method determining unit 101 returns to step S201. Contrarily, if there is the acoustic event being notified (YES in step S202), the reproduction sound source notification method determining unit 101 proceeds to step S206.

Meanwhile, if an acoustic event has been detected by the recognition processing in step S201 (YES in step S201), the reproduction sound source notification method determining unit 101 determines whether or not the detected acoustic event is a known event, namely, whether or not the acoustic event has been detected in recognition processing (step S201) preceding the previous recognition processing (step S201) (step S203). In a case where the acoustic event is known (YES in step S203), the reproduction sound source notification method determining unit 101 proceeds to step S206.

Contrarily, if the acoustic event has been detected for the first time in the present operation (NO in step S203), the reproduction sound source notification method determining unit 101 performs matching between a feature amount of the acoustic event and a feature amount of the object detected from the sensor data acquired by other sensors (the camera 51 or the others) (step S204). Note that the feature amount of the acoustic event and the feature amount of the object may be, for example, a feature amount generated by the feature amount conversion unit 141 (see FIG. 20 and the like) when each of the acoustic event and the object has been detected or may be a feature amount newly extracted by the reproduction sound source notification method determining unit 101 from each of the acoustic event and the object.

If the matching between the acoustic event and the object fails (NO in step S204), the reproduction sound source notification method determining unit 101 proceeds to step S206. Contrarily, if the matching is successful (YES in step S204), the acoustic event and the object for which the matching has been successful are associated with other (step S205), and the process proceeds to step S206.

In step S206, the reproduction sound source notification method determining unit 101 determines whether or not the acoustic event (or the object) has been lost, and if the acoustic event (or the object) is not lost, namely, if the acoustic event has been continuously tracked (NO in step S206), the process proceeds to step S207. Contrarily, if the acoustic event (or the object) has been lost (YES in step S206), the reproduction sound source notification method determining unit 101 proceeds to step S211.

In step S207, the reproduction sound source notification method determining unit 101 resets the value of a counter since the acoustic event (or the object) has been continuously tracked. Subsequently, the reproduction sound source notification method determining unit 101 initializes the angular range (also referred to as the display range) of the display direction in the display application 150 to the initial display range (for example, the narrowest display range) (step S207). Note that, if the display range is the initial value immediately before step S207, step S207 may be skipped.

Next, the reproduction sound source notification method determining unit 101 determines whether or not the relative position between the vehicle 1 and the sound source of the acoustic event has changed (step S209), and if not (NO in step S209), the process proceeds to step S215. Contrarily, if the relative position has changed (YES in step S209), the reproduction sound source notification method determining unit 101 updates the display direction in the display application 150 on the basis of the changed relative position (step S210) and proceeds to step S215.

Furthermore, in step S211, the reproduction sound source notification method determining unit 101 updates the value of the counter by incrementing the value by 1 since the acoustic event (or the object) has been lost. Subsequently, the reproduction sound source notification method determining unit 101 determines whether or not a predetermined period of time has elapsed since the acoustic event (or the object) has been lost on the basis of the value of the counter (step S212). If the predetermined period of time has elapsed (YES in step S212), the reproduction sound source notification method determining unit 101 cancels the notification to the user using the display application 150 or the like of the target acoustic event (step S213) and proceeds to step S215. Contrarily, if the predetermined period of time has not yet elapsed (NO in step S212), the reproduction sound source notification method determining unit 101 updates the display range to be expanded by one stage (step S214) and proceeds to step S215. Note that, in step S214, the reproduction sound source notification method determining unit 101 may adjust the display direction in the display application 150 in consideration of the traveling direction and the traveling speed of the acoustic event (or the object) so far. Note that the predetermined period of time for determining cancellation of the notification may be modifiable by the user using the input unit 134 or voice input.

In step S215, the reproduction sound source notification method determining unit 101 determines whether or not to end the present operation and ends the operation if the operation is to be ended (YES in step S215). Contrarily, if the operation is not to be ended (NO in step S215), the reproduction sound source notification method determining unit 101 returns to step S201 and continues the subsequent operations.

### 1.20 Operation Mode Examples

Appropriate notification timing of the detected acoustic event may vary depending on the driver and the driving situation. For example, even for the same driver, desirable timing for notification may vary depending on a road on which the driver is traveling, time of the day, a traffic condition, or others. Therefore, in the present embodiment, a plurality of operation modes having different notification timing may be prepared, and the operation mode may be switched depending on selection by the driver, a road on which the vehicle is traveling, time of the day, a traffic condition, or others.

In the present embodiment, three operation modes of an automatic operation mode, a user operation mode, and an event presentation mode are described as exemplary operation mode.

### (Automatic Operation Mode)

The automatic operation mode is an operation mode for acquiring various types of data such as road traffic information obtained by analyzing sensor data acquired by the camera 51 or the others, steering information from the vehicle sensor 27, operation information from the vehicle control unit 32, or traffic condition information acquired via the communication unit 111 (communication unit 22), predicting a user's action in real time from the various types of data that have been acquired, and executing reproduction of external sound (corresponding to environmental sound) and notification using the display application 150 at timing when driving assistance is necessary. In the automatic operation mode, for example, the approach of a vehicle on a road with poor visibility is notified by capturing and reproducing external sound.

### (User Operation Mode)

The user operation mode is an operation mode in which the driver acquires the environmental voice or necessary external sound by operating the input unit 134 at timing when the driver desires to rely on the external sound and the acquired external sound is notified to the driver. In the user operation mode, for example, it is possible to recognize the approach of a child not captured in the camera or the like by reproducing sound around the rear side in the vehicle during the attention is being paid to the rear side while the vehicle is traveling backward.

### (Event Presentation Mode)

The event presentation mode is an operation mode in which the type and the direction of the sound are notified to the user using an analysis result of the external sound, and external sound selected by the user is reproduced in the vehicle. In the event presentation mode, for example, by using speech recognition and semantic analysis technology, in a case where it is detected that the user is talking about a specific event outside the vehicle from the conversation in the vehicle, and in a case where an acoustic event corresponding to the specific event is detected, operation can be performed such that the acoustic event is reproduced in the vehicle. The sound of the event that is enhanced by signal processing in the event presentation mode can be recognized of its features more clearly than listening to the sound with a window opened. Furthermore, in a case where the content of the conversation includes a negative statement, namely, a statement that specific sound (for example, a construction site or the like) is noisy, applications such as increasing the volume of an in-vehicle audio device or reproducing, from a speaker, masking noise that makes it difficult to hear the sound of the mentioned acoustic event are also conceivable.

As described above, with the operation modes corresponding on the driver or the driving situation, it is made possible to reduce reproduction at timing not intended by the driver or to detect a necessary acoustic event at necessary timing. Furthermore, it is also possible to estimate the user's action in cooperation with the steering wheel operation, the gear operation, the orientation of the face, or others and to notify the user of information in a necessary direction. Furthermore, visually notifying information of a detected acoustic event enables the user to intuitively operate necessary sound information. Furthermore, by performing speech recognition and semantic analysis, it is also made possible to capture or to suppress sound outside the vehicle without requiring a user operation.

Next, the above-described operation modes will be described in more detail below.

### 1.20.1 Automatic Operation Mode

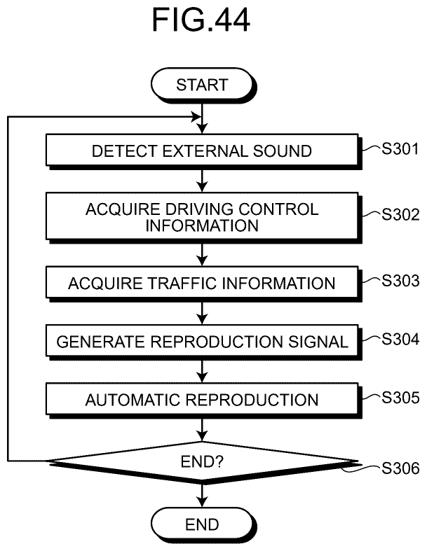

FIG. 44 is a diagram for describing a detailed flow example of the automatic operation mode according to the present embodiment. As illustrated in FIG. 44, in the present operation mode, the reproduction sound source notification method determining unit 101 detects external sound by executing recognition processing on an audio signal (or environmental sound data) input from the exterior microphone 112 (step S301).

Next, the reproduction sound source notification method determining unit 101 acquires steering information from the vehicle sensor 27, operation information and the like from the vehicle control unit 32 (hereinafter, these are also referred to as driving control information) (step S302) and acquires road traffic information obtained by analyzing sensor data acquired by the camera 51 or the others, traffic condition information and the like acquired via the communication unit 111 (communication unit 22) (hereinafter, these are also referred to as traffic information) (step S303).

Next, the reproduction sound source notification method determining unit 101 generates an audio signal (also referred to as a reproduction signal) of external sound to be reproduced in the vehicle from among the external sound detected in step S301 on the basis of at least a part of the driving control information and the traffic information (step S304).

Next, the reproduction sound source notification method determining unit 101 inputs the generated reproduction signal to the notification control unit 102 and causes the speaker 131 to output the reproduction signal, thereby automatically reproducing specific external sound in the vehicle (step S305).

Then, the reproduction sound source notification method determining unit 101 determines whether or not to end the present operation mode (step S306), and if the operation mode is to be ended (YES in step S306), the operation mode is ended. Contrarily, if the operation is not to be ended (NO in step S306), the reproduction sound source notification method determining unit 101 returns to step S301 and executes the subsequent operations.

As described above, in the automatic operation mode, the external sound is reproduced in the vehicle for the purpose of driving assistance on the basis of the sensor data obtained by the exterior microphone 112, the camera 51, or the others, the driving control information, or the traffic information. Note that in a case where the speaker 131 is a multi-speaker, the direction from which an object is approaching may be expressed by sound using the speaker 131. However, it is not limited thereto, and the direction from which the object is approaching may be notified using the display 132 or the indicator 133.

In the present operation mode, for example, by utilizing sound information, it is possible to issue a warning to the user about an approaching object from a range that cannot be seen by the camera 51 or others.

### 1.20.2 User Operation Mode

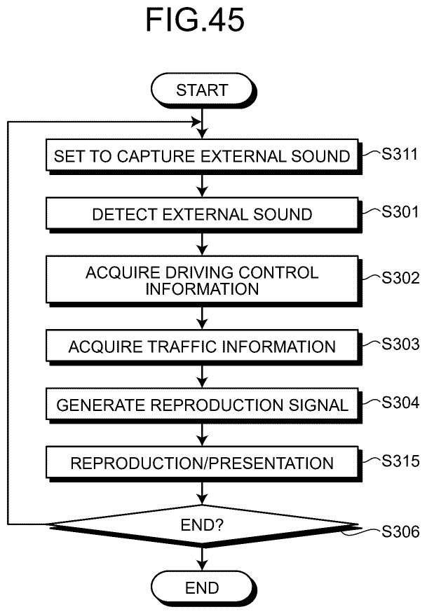

FIG. 45 is a diagram for describing a detailed flow example of the user operation mode according to the present embodiment. Note that, in the following description, steps similar to those in the operation flow illustrated in FIG. 44 are cited, and redundant description is omitted.

As illustrated in FIG. 45, in the present operation mode, the reproduction sound source notification method determining unit 101 first receives, from the user, settings related to the notification method of the external sound taken into the vehicle (step S311). For example, the user can set to notify the external sound using one or more of the speaker 131, the display 132, or the indicator 133.

Next, the reproduction sound source notification method determining unit 101 generates a reproduction signal of the external sound to be reproduced in the vehicle by executing operations similar to those in steps S301 to S304 in FIG. 44. Note that, in step S311, in a case where the speaker 131 is set as the notification method, the reproduction signal may be an audio signal of the external sound. However, in a case where the display 132 or the indicator 133 is set, the reproduction signal may be information such as a display direction, a distance, or an icon to be displayed on the display application 150.

Next, the reproduction sound source notification method determining unit 101 reproduces and presents the reproduction signal generated in step S304 to the user in accordance with the notification method set in step S311 (step S315).

Then, the reproduction sound source notification method determining unit 101 determines whether or not to end the present operation mode (step S306), and if the operation mode is to be ended (YES in step S306), the operation mode is ended. Contrarily, if the operation is not to be ended (NO in step S306), the reproduction sound source notification method determining unit 101 returns to step S311 and executes the subsequent operations.

As described above, in the user operation mode, in a case where the driver passes on an unfamiliar road that the driver usually does not travel on, or in a case where the vehicle 1 is caused to travel backward, the driver can enable the function of capturing external sound by the user's own will in cases where the driver desires to look around or further acquire information in the direction of attention in accordance with an action of gazing at the rearview mirror or the back monitor. Note that various methods such as voice input or a switch may be applied to the setting operation in step S311.

### 1.20.3 Event Presentation Mode

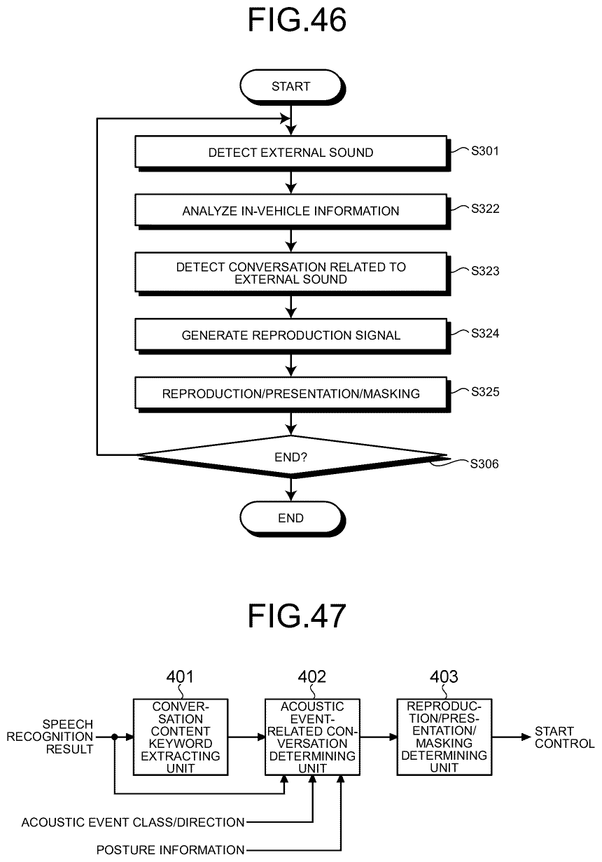

FIG. 46 is a diagram for describing a detailed flow example of the event presentation mode according to the present embodiment. Note that, in the following description, steps similar to those in the operation flow illustrated in FIG. 44 43 are cited, and redundant description is omitted.

As illustrated in FIG. 46, in the present operation mode, the reproduction sound source notification method determining unit 101 detects the external sound by executing recognition processing on the audio signal (or the environmental sound data) input from the exterior microphone 112 by an operation similar to that in step S301 in FIG. 44 (step S301).

Next, the reproduction sound source notification method determining unit 101 analyzes the image data acquired by the in-vehicle camera 113 and the audio signal acquired by the in-vehicle microphone 114 to acquire information (hereinafter, also referred to as in-vehicle information) such as the state of the user in the vehicle and the conversation in the vehicle (step S322).

Next, the reproduction sound source notification method determining unit 101 detects a conversation related to the external sound detected in step S301 from the in-vehicle information acquired in step S322 (step S323).

Next, the reproduction sound source notification method determining unit 101 generates a reproduction signal for reproducing, emphasizing, or suppressing the external sound related to the conversation detected in step S323 (step S324). Note that, in a case where there is a plurality of acoustic events related to an onboard conversation, an acoustic event to be notified may be selected on the basis of the degree of relevance between the two. For example, one or more highly relevant acoustic events may be notified to the user. Furthermore, in a case where the display 132 or the indicator 133 is set as the notification method, the reproduction signal may be information such as the display direction, the distance, or an icon to be displayed on the display application 150.

Next, the reproduction sound source notification method determining unit 101 reproduces, presents, or masks the reproduction signal generated in step S324 to provide the user with a notification or control depending on the conversation made in the vehicle (step S325).

Then, the reproduction sound source notification method determining unit 101 determines whether or not to end the present operation mode (step S306), and if the operation mode is to be ended (YES in step S306), the operation mode is ended. Contrarily, if the operation is not to be ended (NO in step S306), the reproduction sound source notification method determining unit 101 returns to step S301 and executes the subsequent operations.

As described above, the audio signal acquired by the exterior microphone 1122 can be used for other purposes than driving assistance. By presenting an acoustic event of the external sound related to a conversation in the vehicle to the user, it is possible to provide a topic to the user in the vehicle, or conversely, in a case where the user is talking about an outside view, it is possible to take the sound of a target object to the inside of the vehicle.

### 1.21 Notification Method for Acoustic Event Utilizing Onboard Conversation

As described above, a conversation in the vehicle can be acquired by performing speech recognition on an audio signal (onboard sound data) acquired by the in-vehicle microphone 114. It is further possible to change the notification method to the user of the acoustic event on the basis of the content of the onboard conversation specified by the speech recognition.

### 1.21.1 Configuration Example

FIG. 47 is a diagram for describing a configuration for changing a notification method of an acoustic event on the basis of an onboard conversation according to the present embodiment. As illustrated in FIG. 47, the configuration for performing speech recognition on the onboard conversation includes a conversation content keyword extracting unit 401, an acoustic event-related conversation determining unit 402, and a reproduction/presentation/masking determining unit 403.

For example, the conversation content keyword extracting unit 401 detects a keyword of the onboard conversation from a speech recognition result obtained by executing speech recognition on onboard sound data acquired by the sound acquisition unit 124 (see FIG. 3). Note that the extracted keyword may be a word that coincides with a keyword candidate registered in advance or may be a word extracted using a machine learning algorithm or the like.

The acoustic event-related conversation determining unit 402 receives input of the speech recognition result obtained by executing the speech recognition on the onboard sound data, the keyword extracted by the conversation content keyword extracting unit 401, the class of the acoustic event acquired by the reproduction sound source notification method determining unit 101 and the sound direction thereof, and the posture information of the user detected by the posture recognition unit 123. The acoustic event-related conversation determining unit 402 specifies an acoustic event related to the onboard conversation from among acoustic events detected by the reproduction sound source notification method determining unit 101 on the basis of these pieces of input information. Furthermore, the acoustic event-related conversation determining unit 402 may specify whether the content of the conversation related to the acoustic event is a positive content or a negative content from the keyword extracted from the onboard conversation or the state inside the vehicle that is specified from the posture information of the user.

With respect to the acoustic event specified by the acoustic event-related conversation determining unit 402, on the basis of whether the content of the onboard conversation related to the acoustic event is positive or negative, the reproduction/presentation/masking determining unit 403 determines whether to perform normal or enhanced reproduction of the acoustic event, to perform presentation to the user using the display application 150, or to perform masking to make it difficult for the user to hear the acoustic event. For example, in a case where the content of the conversation related to the acoustic event is positive, it is possible to liven up the onboard conversation by notifying the user of the acoustic event by voice or an image. Contrarily, for example, in a case where the content of the conversation related to the acoustic event is negative, it is possible to avoid the onboard conversation from being hindered by masking the acoustic event to make it difficult for the user to hear the acoustic event.

Note that examples of reproduction, presentation, and masking of the acoustic event include in-vehicle reproduction of sound, presentation of the acoustic event using the display application 150, masking of sound, increasing volume of the car audio device, and adjustment of an equalizer.

In addition, in speech recognition, road noise and the car audio device serve as noise sources and cause deterioration in speech recognition performance. Therefore, speech recognition performance can be improved by performing preprocessing such as noise suppression, multichannel voice enhancement, and acoustic echo cancellation.

A part or all of the speech recognition may be executed in the reproduction sound source notification method determining unit 101, may be executed in another information processing device mounted on the vehicle 1 and connected with the vehicle control system 11 via the CAN, or may be executed in a server (including a cloud server) arranged on a network outside the vehicle to which the acoustic control device 100 such as the Internet and/or the vehicle control system 11 can be connected via the communication unit 111 and/or the communication unit 22, or others.

Similarly, at least one of the conversation content keyword extracting unit 401, the acoustic event-related conversation determining unit 402, and the reproduction/presentation/masking determining unit 403 may be a part of the reproduction sound source notification method determining unit 101 or may be disposed in another information processing device mounted on the vehicle 1 and connected with the vehicle control system 11 via the CAN, a server (including a cloud server) disposed on a network outside the vehicle to which the acoustic control device 100 such as the Internet and/or the vehicle control system 11 can be connected via the communication unit 111 and/or the communication unit 22, or the like.

For example, it is also possible to configure such that speech recognition is executed by a cloud server on a network and that a result thereof is received by the vehicle 1 to execute subsequent processing locally. In this case, it is possible to specify which keyword is related to which acoustic event by receiving the speech recognition result as text and performing matching with or specifying the relevance with an event class keyword of an acoustic event.

Furthermore, posture information such as the orientation or the posture of the face of the user in the vehicle may be specified on the basis of the image data from the in-vehicle camera 113, and in a case where a keyword of the conversation, an acoustic event, and a direction thereof are closely related to each other, it may be determined that the user is talking about the sound outside the vehicle, and visual presentation of the acoustic event or in-vehicle reproduction may be executed.

Furthermore, in order to determine whether the onboard conversation is positive or negative, vital information or the like acquired by a smart device attached to the user may be used in addition to the conversation content or the posture information. Determination using vital information or the like makes it possible to determine whether it is positivity or negative with higher accuracy, whereby notification corresponding to the onboard conversation can be made more accurately.

### 1.21.2 Operation Example

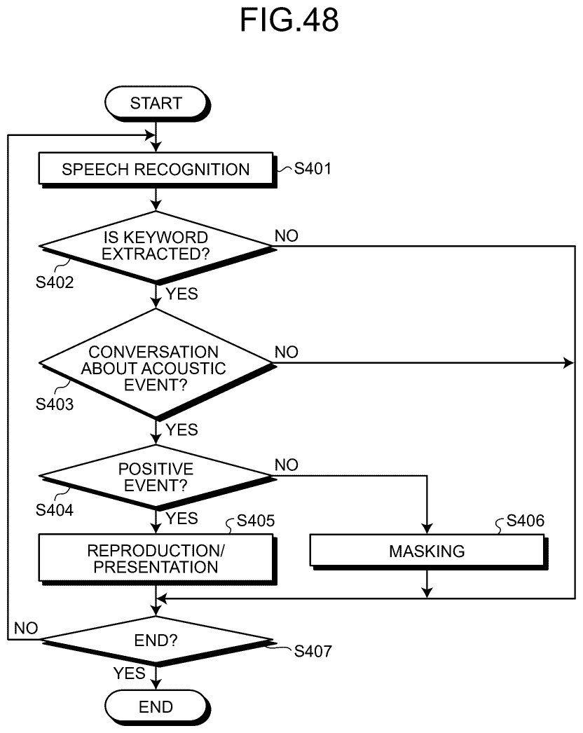

FIG. 48 is a flowchart illustrating an operation example when a notification method for an acoustic event is changed on the basis of an onboard conversation according to the present embodiment. As illustrated in FIG. 48, in the present operation, first, speech recognition processing is executed on sound data acquired by the in-vehicle microphone 114 (step S401).

Next, the conversation content keyword extracting unit 401 executes processing of extracting a keyword of the onboard conversation from the speech recognition result (step S402). If no keyword is extracted from the onboard conversation (NO in step S402), the present operation proceeds to step S407. Contrarily, if a keyword is extracted (YES in step S402), the present operation proceeds to step S403.

In step S403, the acoustic event-related conversation determining unit 402 executes processing of specifying an acoustic event related to the onboard conversation among acoustic events detected by the reproduction sound source notification method determining unit 101 by referring to the keyword extracted in step S402, the class of the acoustic event and the sound direction thereof acquired by the reproduction sound source notification method determining unit 101, and the posture information of the user detected by the posture recognition unit 123. If no acoustic event related to the onboard conversation has been specified (NO in step S403), the present operation proceeds to step S407. Contrarily, if an acoustic event related to the onboard conversation is specified (YES in step S403), the present operation proceeds to step S404.

In step S404, the acoustic event-related conversation determining unit 402 executes processing of specifying whether the content of the conversation related to the acoustic event is a positive content or a negative content from the keyword extracted from the onboard conversation or the state inside the vehicle that is specified from the posture information of the user.

If the content of the conversation related to the acoustic event is positive (YES in step S404), the reproduction/presentation/masking determining unit 403 performs normal or enhanced reproduction of the acoustic event specified by the acoustic event-related conversation determining unit 402 or presents the acoustic event to the user using the display application 150 (step S405), and the present operation proceeds to step S407.

On the other hand, if the content of the conversation related to the acoustic event is negative (NO in step S404), the reproduction/presentation/masking determining unit 403 masks the acoustic event specified by the acoustic event-related conversation determining unit 402 so as not to be heard by the user (step S406), and the present operation proceeds to step S407.

Then, in step S407, it is determined whether or not to end the present operation mode, and if the present operation mode is to be ended (YES in step S407), the present operation mode is ended. Contrarily, if the operation mode is not to be ended (NO in step S407), the present operation returns to step S401, and the subsequent operations are executed.

### 1.21.3 Exemplary Elements Used for Keyword Determination

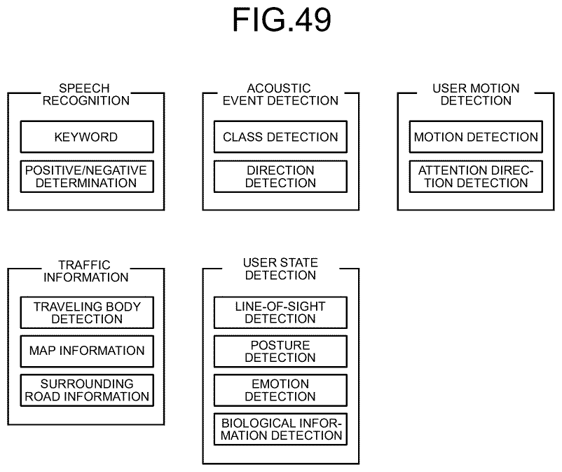

FIG. 49 is a diagram illustrating an example of elements used when it is determined whether or not an acoustic event extracted from the onboard conversation in step S403 of FIG. 48 is related to an acoustic event. As illustrated in FIG. 49, exemplary elements used for keyword determination include a “keyword” and “positive/negative determination” obtained by speech recognition, a result of “class detection” and a result of “direction detection” obtained by acoustic event detection, a result of “motion detection” and a result of “attention direction detection” obtained by user motion detection, a result of “moving body detection”, “map information”, and “road traffic information” obtained from traffic information, a result of “line-of-sight detection” obtained by user state detection, a result of “posture detection”, a result of “emotion detection”, and a result of “biological information detection”.

### 2. Hardware Configuration

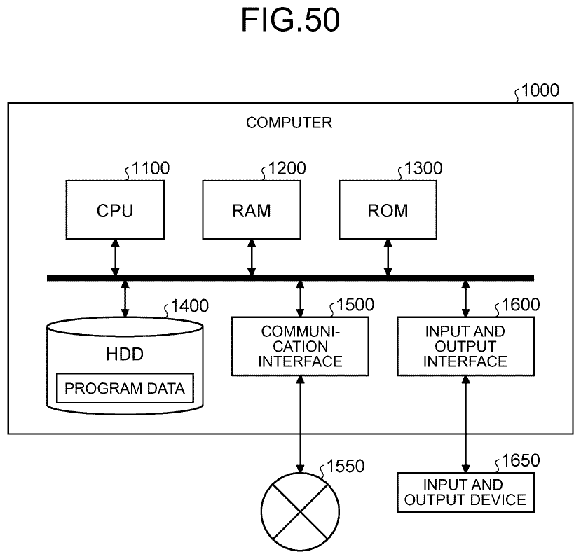

The units according to the embodiment, the modifications thereof, and the application example described above can be implemented by a computer 1000 having a configuration as illustrated in FIG. 50, for example. FIG. 50 is a hardware configuration diagram illustrating an example of the computer 1000 that implements functions of the units according to the present disclosure. The computer 1000 includes a CPU 1100, a RAM 1200, a read only memory (ROM) 1300, a hard disk drive (HDD) 1400, a communication interface 1500, and an input and output interface 1600. The components of the computer 1000 are connected by a bus 1050.

The CPU 1100 operates in accordance with a program stored in the ROM 1300 or the HDD 1400 and controls each of the components. For example, the CPU 1100 loads a program stored in the ROM 1300 or the HDD 1400 in the RAM 1200 and executes processing corresponding to various programs.

The ROM 1300 stores a boot program such as a basic input output system (BIOS) executed by the CPU 1100 when the computer 1000 is activated, a program dependent on the hardware of the computer 1000, and the like.

The HDD 1400 is a computer-readable recording medium that non-transiently records a program to be executed by the CPU 1100, data used by such a program, and the like. Specifically, the HDD 1400 is a recording medium that records a projection control program according to the present disclosure, which is an example of program data 1450.

The communication interface 1500 is an interface for the computer 1000 to be connected with an external network 1550 (for example, the Internet). For example, the CPU 1100 receives data from another device or transmits data generated by the CPU 1100 to another device via the communication interface 1500.

The input and output interface 1600 includes the above-described I/F unit 18 and is an interface for connecting an input and output device 1650 and the computer 1000. For example, the CPU 1100 receives data from an input device such as a keyboard or a mouse via the input and output interface 1600. In addition, the CPU 1100 transmits data to an output device such as a display, a speaker, or a printer via the input and output interface 1600. Furthermore, the input and output interface 1600 may function as a media interface that reads a program or the like recorded in a predetermined recording medium. A medium refers to, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, the CPU 1100 of the computer 1000 functions as the units of the above-described embodiments by executing a program loaded on the RAM 1200. In addition, the HDD 1400 stores the program and the like according to the present disclosure. Note that although the CPU 1100 reads the program data 1450 from the HDD 1400 and executes the program data 1450, as another example, these programs may be acquired from another device via the external network 1550.

Although the embodiments of the disclosure have been described above, the technical scope of the disclosure is not limited to the above embodiments as they are, and various modifications can be made without departing from the gist of the disclosure. In addition, components of different embodiments and modifications may be combined as appropriate.

Furthermore, the effects of the embodiments described herein are merely examples and are not limiting, and other effects may be achieved.

Note that the present technology can also have the following configurations.

(1)

An acoustic control method comprising:
acquiring sensor data from two or more sensors mounted on a moving body that moves in a three-dimensional space;
acquiring a position of the moving body;
specifying a sound source and a position of the sound source outside the moving body on a basis of output of acoustic event information acquisition processing using the sensor data as input; and
displaying, on a display, a moving body icon corresponding to the moving body, wherein
the display further displays metadata of the sound source that has been specified in a visually identifiable manner reflecting a relative positional relationship between the position of the moving body and the position of the sound source that has been specified.
   (2)

The acoustic control method according to (1) wherein
the two or more sensors include at least two acoustic sensors.
   (3)

The acoustic control method according to (2) wherein
the acoustic sensor is a microphone.
   (4)

The acoustic control method according to any one of (1) to (3) wherein
the acoustic event information acquisition processing includes a machine learning algorithm.
   (5)

The acoustic control method according to (4) wherein
the machine learning algorithm is a deep neural network.
   (6)

The acoustic control method according to any one of (1) to (5) wherein
the metadata of the sound source includes event feature data related to a feature of an event of the sound source that has been specified.
   (7)

The acoustic control method according to (6) wherein
displaying the metadata of the sound source includes identifiably assigning at least one of a color, a ratio, and a display area to each piece of the event feature data.
   (8)

The acoustic control method according to (6) or (7) wherein
displaying the metadata of the sound source includes displaying the metadata in accordance with a priority ranking specified on a basis of the event feature data.
   (9)

The acoustic control method according to any one of (1) to (8) wherein
the moving body icon is displayed to overlap with map data displayed on the display, and an icon of the sound source that has been specified is further displayed on the map.
   (10)

The acoustic control method according to (9) further comprising:
acquiring time and recording the time in association with the position of the moving body and the sound source and the position of the sound source that have been specified.
   (11)

The acoustic control method according to (10) further comprising:
displaying the position of the moving body at a predetermined time and the sound source and the position of the sound source that have been specified on the display on a basis of instruction input by a user.
   (12)

The acoustic control method according to (11) wherein
the instruction input by the user is input for changing the predetermined time.
   (13)

The acoustic control method according to (11) or (12) wherein
the instruction input by the user is voice input.
   (14)

The acoustic control method according to any one of (1) to (13) further comprising:
outputting sound of the sound source that has been specified to at least one of one or more speakers inside the moving body.
   (15)

The acoustic control method according to (14) wherein
the at least one speaker is installed in a vicinity of a user who controls the moving body.
   (16)

The acoustic control method according to any one of (1) to (15) further comprising:
performing speech recognition based on input of a microphone inside the moving body; and
displaying the metadata of the sound source that has been specified depending on a degree of relevance between an event specified by the speech recognition and an event of the sound source that has been specified.
   (17)

The acoustic control method according to any one of (1) to (16) wherein
the two or more sensors further include an image sensor, and
the sensor data includes data related to a detected object.
   (18)

The acoustic control method according to any one of (6) to (8) wherein
the metadata of the sound source further includes object feature data related to an object of the sound source that has been specified.
   (19)

The acoustic control method according to (18) wherein
specifying the position of the sound source includes specifying a relationship between the event feature data and the object feature data, and
the display further updates display in a case where the relative positional relationship between the position of the moving body and the position of the sound source that has been specified is changed.
   (20)

An acoustic control device comprising:
a data acquisition unit that acquires sensor data from two or more sensors mounted on a moving body that moves in a three-dimensional space;
a position acquisition unit that acquires a position of the moving body;
a specifying unit that specifies a sound source and a position of the sound source outside the moving body on a basis of output of acoustic event information acquisition processing using the sensor data as input; and
a display control unit that displays, on a display, a moving body icon corresponding to the moving body, wherein the display control unit further displays, on the display, metadata of the sound source that has been specified in a visually identifiable manner reflecting a relative positional relationship between the position of the moving body and the position of the sound source that has been specified.

### REFERENCE SIGNS LIST

1 VEHICLE
11 VEHICLE CONTROL SYSTEM
21 PROCESSOR
22, 111 COMMUNICATION UNIT
23 MAP INFORMATION ACCUMULATING UNIT
24 GNSS RECEPTION UNIT
25 EXTERNAL RECOGNITION SENSOR
26 IN-VEHICLE SENSOR
27 VEHICLE SENSOR
28 RECORDING UNIT
29 TRAVEL ASSISTANCE AND AUTONOMOUS DRIVING CONTROL UNIT
30 DMS
31 HMI
32, 125 VEHICLE CONTROL UNIT
51 CAMERA
52 RADAR
53 LIDAR
54 ULTRASONIC SENSOR
55 MICROPHONE
61 ANALYSIS UNIT
62 ACTION PLANNING UNIT
63 OPERATION CONTROL UNIT
71 SELF-POSITION ESTIMATION UNIT
72 SENSOR FUSION UNIT
73 RECOGNITION UNIT
81 STEERING CONTROL UNIT
82 BRAKE CONTROL UNIT
83 DRIVE CONTROL UNIT
84 BODY SYSTEM CONTROL UNIT
85 LIGHT CONTROL UNIT
86 HORN CONTROL UNIT
100 ACOUSTIC CONTROL DEVICE
101 REPRODUCTION SOUND SOURCE NOTIFICATION METHOD DETERMINING UNIT
102 NOTIFICATION CONTROL UNIT
112 EXTERIOR MICROPHONE
112-1 to 112-4 DIRECTIONAL MICROPHONE
112-5 to 112-8 OMNIDIRECTIONAL MICROPHONE
112a MICROPHONE
113 IN-VEHICLE CAMERA
114 IN-VEHICLE MICROPHONE
121 TRAFFIC CONDITION ACQUISITION UNIT
122 ENVIRONMENTAL SOUND ACQUISITION UNIT
123 POSTURE RECOGNITION UNIT
124 SOUND ACQUISITION UNIT
131, 131a, 131b, 131c SPEAKER
132 DISPLAY
133, 151a, 151b, 155 INDICATOR
134 INPUT UNIT
141 FEATURE AMOUNT CONVERSION UNIT
142 ACOUSTIC EVENT INFORMATION ACQUISITION UNIT
150 DISPLAY APPLICATION
152, 153a DISC CHART
153b, 154a, 154b, 155a to 155c ICON
161 SELECTION MENU
200 NOTIFICATION CONTROL DEVICE
201 NOTIFICATION PRIORITY DETERMINING UNIT
202 NOTIFICATION CANCELLATION DETERMINING UNIT
222 EMERGENCY VEHICLE DETECTING UNIT
223 LINE-OF-SIGHT DETECTION UNIT
224 VOICE COMMAND DETECTION UNIT
225 POSITIONAL RELATIONSHIP ESTIMATION UNIT
226 STEERING INFORMATION ACQUISITION UNIT
401 CONVERSATION CONTENT KEYWORD EXTRACTING UNIT
402 ACOUSTIC EVENT-RELATED CONVERSATION DETERMINING UNIT
403 REPRODUCTION/PRESENTATION/MASKING DETERMINING UNIT

1. An acoustic control method comprising:
acquiring sensor data from two or more sensors mounted on a moving body that moves in a three-dimensional space;
acquiring a position of the moving body;
specifying a sound source and a position of the sound source outside the moving body on a basis of output of acoustic event information acquisition processing using the sensor data as input; and
displaying, on a display, a moving body icon corresponding to the moving body, wherein
the display further displays metadata of the sound source that has been specified in a visually identifiable manner reflecting a relative positional relationship between the position of the moving body and the position of the sound source that has been specified.

2. The acoustic control method according to claim 1, wherein
the two or more sensors include at least two acoustic sensors.

3. The acoustic control method according to claim 2, wherein
the acoustic sensor is a microphone.

4. The acoustic control method according to claim 1, wherein
the acoustic event information acquisition processing includes a machine learning algorithm.

5. The acoustic control method according to claim 4, wherein
the machine learning algorithm is a deep neural network.

6. The acoustic control method according to claim 1, wherein
the metadata of the sound source includes event feature data related to a feature of an event of the sound source that has been specified.

7. The acoustic control method according to claim 6, wherein
displaying the metadata of the sound source includes identifiably assigning at least one of a color, a ratio, and a display area to each piece of the event feature data.

8. The acoustic control method according to claim 6, wherein
displaying the metadata of the sound source includes displaying the metadata in accordance with a priority ranking specified on a basis of the event feature data.

9. The acoustic control method according to claim 1, wherein
the moving body icon is displayed to overlap with map data displayed on the display, and an icon of the sound source that has been specified is further displayed on the map.

10. The acoustic control method according to claim 9, further comprising:
acquiring time and recording the time in association with the position of the moving body and the sound source and the position of the sound source that have been specified.

11. The acoustic control method according to claim 10, further comprising:
displaying the position of the moving body at a predetermined time and the sound source and the position of the sound source that have been specified on the display on a basis of instruction input by a user.

12. The acoustic control method according to claim 11, wherein
the instruction input by the user is input for changing the predetermined time.

13. The acoustic control method according to claim 11, wherein
the instruction input by the user is voice input.

14. The acoustic control method according to claim 1, further comprising:
outputting sound of the sound source that has been specified to at least one of one or more speakers inside the moving body.

15. The acoustic control method according to claim 14, wherein
the at least one speaker is installed in a vicinity of a user who controls the moving body.

16. The acoustic control method according to claim 1, further comprising:
performing speech recognition based on input of a microphone inside the moving body; and
displaying the metadata of the sound source that has been specified depending on a degree of relevance between an event specified by the speech recognition and an event of the sound source that has been specified.

17. The acoustic control method according to claim 1, wherein
the two or more sensors further include an image sensor, and
the sensor data includes data related to a detected object.

18. The acoustic control method according to claim 6, wherein
the metadata of the sound source further includes object feature data related to an object of the sound source that has been specified.

19. The acoustic control method according to claim 18, wherein
specifying the position of the sound source includes specifying a relationship between the event feature data and the object feature data, and
the display further updates display in a case where the relative positional relationship between the position of the moving body and the position of the sound source that has been specified is changed.

20. An acoustic control device comprising:
a data acquisition unit that acquires sensor data from two or more sensors mounted on a moving body that moves in a three-dimensional space;
a position acquisition unit that acquires a position of the moving body;
a specifying unit that specifies a sound source and a position of the sound source outside the moving body on a basis of output of acoustic event information acquisition processing using the sensor data as input; and
a display control unit that displays, on a display, a moving body icon corresponding to the moving body, wherein
the display control unit further displays, on the display, metadata of the sound source that has been specified in a visually identifiable manner reflecting a relative positional relationship between the position of the moving body and the position of the sound source that has been specified.
